(19) United States
(12) Patent Application Publication
(10) Pub. No.: US 2026/0048345 A1
(43) Pub. Date: Feb. 19, 2026

(54) CARBON DIOXIDE EXTRACTION

(71) Applicant: GIGATON CO2 LTD, Leigh Lancashire (GB)

(72) Inventors: David GLEESON, Leigh Lancashire (GB); Thomas John MCKECHNIE, Leigh Lancashire (GB)

(73) Assignee: GIGATON CO2 LTD, Leigh Lancashire, GB (GB)

(21) Appl. No.: 18/996,102

(22) PCT Filed: Jul. 19, 2023
(86) PCT No.: PCT/GB2023/051887

§ 371 Date: Jan. 17, 2025

(30) Foreign Application Priority Data
Jul. 19, 2022 (GB) 2210565.4
Oct. 31, 2022 (GB) 2216114.5
Nov. 25, 2022 (GB) 2217710.9

(51) Int. Cl. B01D 19/00; B01D 53/14; C01B 32/50; C02F 1/20; C02F 1/66; C02F 101/10

(52) U.S. Cl. CPC B01D 19/0036; B01D 53/1425; B01D 53/1475; B01D 53/1493; C01B 32/50; C02F 1/20; C02F 1/66; B01D 2252/1035; B01D 2257/504; C02F 2101/10

(57) ABSTRACT

The disclosure provides a method of capturing carbon dioxide. The method comprises providing an input liquid. The input liquid comprises carbon dioxide, and/or a precursor thereof, dissolved therein. The method further comprises degassing the input liquid to obtain an output gas comprising carbon dioxide; and capturing the output gas and/or carbon dioxide present in the output gas. The disclosure also provides an apparatus which may be used to conduct the above method.

The present invention relates to the extraction of carbon dioxide from a liquid. In preferred embodiments, the invention relates to the production of a constant stream of carbon dioxide from a water based media.

There is currently approximately 420 ppm of CO₂ in the earth's atmosphere and there are various existing methods in place and proposed technologies for removing CO₂ from the atmosphere with the aim of minimizing the temperature change of the planet to 1.5° C. or below. One of the key issues with CO₂ removal from an atmospheric air stream is that very low amounts of CO₂ are present, thus requiring vast amounts of energy and infrastructure to capture and store any meaningful amount. The cost of capture from such an air stream is extremely expensive and not currently commercially viable.

Numerous technologies to remove CO₂ from atmospheric air have been proposed and are available in the literature, including permeation through a polymer and/or inorganic membranes, removal by adsorbent materials including molecular sieves, cryogenic separation, gas scrubbing with a solvent that reacts chemically with CO₂ and/or a physical solvent. The main drawback of these technologies is they require vast quantities of air to be treated, with associated high costs both financially and environmentally, to reduce the small amounts of CO₂ present. These technologies are also usually not scalable to achieve the removal of gigatons per annum of CO₂ that is suggested will be needed if the temperature change of the planet is to be restricted to 1.5° C. or below.

The present invention arose from the inventors' work in attempting to overcome the problems associated with the prior art.

In accordance with a first aspect of the invention, there is provided a method of capturing carbon dioxide, the method comprising:
providing an input liquid, wherein the input liquid comprises carbon dioxide, and/or a precursor thereof, dissolved therein;
degassing the input liquid to obtain an output gas comprising carbon dioxide; and
capturing the output gas and/or carbon dioxide present in the output gas.

Advantageously, the method produces a gas comprising a high concentration of carbon dioxide which is captured. Accordingly, this carbon dioxide is taken out of the environment. It may be appreciated that the method would generate an output liquid having a lower concentration carbon dioxide and/or the precursor thereof to the input liquid. The output liquid may subsequently be allowed to equilibrate with air, which could cause carbon dioxide from the air to dissolve into the output liquid. Accordingly, the method may thereby have the effect of removing carbon dioxide from the atmosphere.

Furthermore, the method is scalable.

The output gas may comprise a concentration of carbon dioxide of at least 750 ppm, at least 1,000 ppm, at least 5,000 ppm, at least 10,000 ppm, at least 20,000 ppm, at least 30,000 ppm, at least 40,000 ppm or at least 45,000 ppm. In some embodiments, the output gas may comprise a concentration of carbon dioxide of at least 50,000 ppm, at least 75,000 ppm, at least 100,000 ppm, at least 200,000 ppm, at least 300,000 ppm, at least 400,000 ppm, at least 500,000 ppm, at least 600,000 ppm, at least 700,000 ppm, at least 800,000 ppm, at least 900,000 ppm, or 1,000,000 ppm.

The input liquid preferably comprises water. Accordingly, the input liquid may be understood to be a water based medium comprising carbon dioxide, and/or a precursor thereof.

The input liquid may be or comprise any suitable water based medium. For instance, the input liquid may be or comprise fresh water, seawater, produced water, brackish water, wastewater, rainwater, sewerage water, deionized water and/or water containing brine. In some embodiments, the water containing brine may be a brine waste stream from a desalination plant. In some embodiments, the input liquid may be or comprise produced water. It may be appreciated that produced water is water that comes out of an oil well with crude oil during crude oil production. Produced water may be combined with any other suitable water based medium. It is noted that produced water can contain a high concentration of carbonates, and so an input liquid comprising produced water would advantageously be able to provide an output gas with a significant concentration of carbon dioxide.

The carbon dioxide, and/or the precursor thereof, may be present intrinsically in the input liquid. However, in some embodiments, the method may comprise increasing the concentration of carbon dioxide and/or the precursor thereof in the input liquid prior to degassing the input liquid. The concentration of carbon dioxide and/or the precursor thereof in the input liquid may be increased by contacting the input liquid with a gas with a high concentration of carbon dioxide.

The method may comprise pre-treating the gas with a high concentration of carbon dioxide to remove one or more contaminants therefrom prior to contacting the input liquid and the gas with a high concentration of carbon dioxide. The one or more contaminants may comprise sulphur dioxide, sulphuric acid, carbon monoxide, nitrogen oxides, hydrochloric acid, heavy metals (e.g. mercury), hydrocarbons, particulates, and/or ash. Suitable pre-treatment steps may be known in the art.

The method may comprise pre-treating the gas with a high concentration of carbon dioxide to increase the concentration of carbon dioxide therein prior to contacting the input liquid and the gas with a high concentration of carbon dioxide. The concentration of carbon dioxide may be increased using any known technique, such as a membrane, pressure swing adsorption, a microporous and or mesoporous molecular sieve, cryogenic separation, etc.

Contacting the input liquid with the gas with the high concentration of carbon dioxide may comprise bubbling the gas with the high concentration of carbon dioxide through the input liquid. Alternatively, or additionally, contacting the input liquid with the gas with the high concentration of carbon dioxide may comprise contacting the gas with the high concentration of carbon dioxide with a spray of the input liquid. Alternatively, or additionally, contacting the input liquid with the gas with a high concentration of carbon dioxide may comprise contacting the gas with the high concentration of carbon dioxide utilizing any mixing device known to those skilled in the art.

In particular, contacting the input liquid with the gas with the high concentration of carbon dioxide could be used where the gas with the high concentration of carbon dioxide may comprise an impurity. Accordingly, the method may advantageously produce an output gas, with a high concentration of carbon dioxide, which does not contain the impurity.

The gas with a high concentration of carbon dioxide may be a flue and/or exhaust gas. The flue and/or exhaust gas may be from burning a carbon containing fuel and/or from an industrial plant. The industrial plant may be a chemical plant, a refining plant, a desalinating plant, a cement plant, a steel plant and/or other metal smelting plant (e.g. a lead or copper smelting plant) and/or an anaerobic biogas plant. The exhaust gas from burning a carbon containing fuel may be from a power station, an internal combustion engine and/or an open flame.

Alternatively, the gas with a high concentration of carbon dioxide could have been obtained using the method of the first aspect. Accordingly, the method may comprise:
providing a first input liquid, wherein the input first liquid comprises carbon dioxide, and/or a precursor thereof, dissolved therein;
degassing the input first liquid to obtain a first gas with a high concentration of carbon dioxide;
contacting the first gas with a high concentration of carbon dioxide and a second input liquid; and
degassing the second input liquid to obtain a further gas with a high concentration of carbon dioxide.

Alternatively, the method may comprise:
contacting a first gas with a high concentration of carbon dioxide and a first input liquid;
degassing the input first liquid to obtain a second gas with a high concentration of carbon dioxide;
contacting the second gas with a high concentration of carbon dioxide and a second input liquid; and
degassing the second input liquid to obtain a further gas with a high concentration of carbon dioxide.

Preferably, the further gas with a high concentration of carbon dioxide has a higher concentration of carbon dioxide than the first gas with a high concentration of carbon dioxide. Preferably, the further gas with a high concentration of carbon dioxide has a higher concentration of carbon dioxide than the second gas with a high concentration of carbon dioxide.

The further gas with a high concentration of carbon dioxide may be the output gas. Accordingly, the method may comprise capturing the further gas with a high concentration of carbon dioxide and/or carbon dioxide present in the further gas with a high concentration of carbon dioxide.

Alternatively, the method may comprise:
contacting the further gas with a high concentration of carbon dioxide and a further input liquid;
degassing the further input liquid to obtain a still further gas with a high concentration of carbon dioxide.

The above steps may be repeated until a gas with a desired concentration of carbon dioxide is obtained. The method may then comprise capturing this gas and/or carbon dioxide present therein.

Advantageously, the steps above enable a user to increase the concentration of carbon dioxide in the output gas with each iteration of the method.

The inventors have found that the above method can significantly increase the concentration of carbon dioxide in the output gas, to a concentration greater than that in the gas with a high concentration of carbon dioxide. Accordingly, this method can enable the inventors obtain an output gas with a high concentration of carbon dioxide, so no further treatment is necessary.

The gas with a high concentration of carbon dioxide may comprise a concentration of carbon dioxide of at least 500 ppm, at least 1,000 ppm, at least 5,000 ppm, at least 10,000 ppm, at least 20,000 ppm, at least 30,000 ppm, at least 40,000 ppm or at least 45,000 ppm. The gas with a high concentration of carbon dioxide may comprise a concentration of carbon dioxide of at least 50,000 ppm, at least 75,000 ppm, at least 100,000 ppm, at least 125,000 ppm, at least 150,000 ppm, at least 175,000 ppm, at least 200,000 ppm, at least 300,000 ppm, at least 400,000 ppm, at least 500,000 ppm, at least 600,000 ppm, at least 700,000 ppm, at least 800,000 ppm or at least 900,000 ppm. The gas with a high concentration of carbon dioxide may comprise a concentration of carbon dioxide of between 100 and 950,000 ppm, between 500 and 800,000 ppm, between 1,000 and 700,000 ppm, between 5,000 and 600,000 ppm, between 20,000 and 500,000 ppm, between 50,000 and 400,000 ppm, between 100,000 and 300,000 ppm, between 125,000 and 250,000 ppm or between 150,000 and 200,000 ppm. It is noted that, prior to treatment, an exhaust gas from a gas fired power station has a concentration of carbon dioxide of about 30,000 to 50,000 ppm, an exhaust gas from a diesel engine has a concentration of carbon dioxide of about 120,000 ppm, an exhaust gas from a coal fired power station has a concentration of carbon dioxide of about 150,000 ppm and an exhaust gas from a cement or steel plant has a concentration of carbon dioxide of about 300,000 to 350,000 ppm.

The method may comprise venting gas subsequent to contacting the input liquid with the gas with a high concentration of carbon dioxide. The method may comprise venting gas prior to degassing the input liquid. Advantageously, this will vent undissolved gas.

The method may comprise contacting the input liquid with the gas with a high concentration of carbon dioxide in a gassing conduit. The method may comprise causing the gas with a high concentration of carbon dioxide to flow in a first direction along the gassing conduit. The method may comprise causing the gas with a high concentration of carbon dioxide to flow in the first direction from a first point, where the input liquid with the gas with a high concentration of carbon dioxide are contacted, to a second point, where the gas is vented. The second point may be higher than the first point. Preferably, the second point is or defines a local high point in the gassing conduit.

The method may comprise causing the input liquid to travel or flow in the first direction along the gassing conduit. Alternatively, the method may comprise causing the input liquid to travel or flow in a second direction, opposite to the first direction, along the gassing conduit.

The method may comprise contacting the input liquid and the gas with a high concentration of carbon dioxide at approximately atmospheric pressure. In particular, it may be desirable to contacting the input liquid and the gas with a high concentration of carbon dioxide at approximately atmospheric pressure when there is a high volume of the gas with a high concentration of carbon dioxide and/or in embodiments where the gas with a high concentration of carbon dioxide comprises less than 400,000 ppm, less than 350,000 ppm, less than 300,000 ppm, less than 250,000 ppm, 200,000 ppm, less than 150,000 ppm, less than 100,000 ppm, less than 75,000 ppm or less than 50,000 ppm. For instance, the method may comprise contacting the input liquid and the gas with a high concentration of carbon dioxide at approximately atmospheric pressure when the gas with a high concentration of carbon dioxide is a flue and/or exhaust gas. Advantageously, this allows high volumes of flue and/or exhaust gas to be processed at low cost.

The method may be understood to be conducted at approximately atmospheric pressure if it is conducted at a pressure between 50 and 500 kPa, between 60 and 250 kPa, between 70 and 150 kPa, between 80 and 120 kPa, between 90 and 110 kPa or between 95 and 105 kPa.

Alternatively, the method may comprise contacting the input liquid and the gas with a high concentration of carbon dioxide at an increased pressure. The increased pressure may be a pressure of greater than 101 kPa, greater than 110 kPa or greater than 120 kPa, more preferably at least 200 kPa, at least 400 kPa, at least 600 kPa, at least 800 kPa or at least 1 MPa. In some embodiments, the increased pressure may be a pressure of greater than 2 MPa, greater than 4 MPa, greater than 6 MPa, greater than 8 MPa, greater than 10 MPa, greater than 25 MPa, greater than 50 MPa, greater than 75 MPa, greater than 100 MPa or greater than 125 MPa. The increased pressure may be a pressure between 101 kPa and 100 MPa, between no kPa and 50 MPa or between 120 kPa and 20 MPa. It may be appreciated that increasing the pressure will increase the amount of carbon dioxide which is absorbed into the input liquid.

In particular, it may be desirable to contacting the input liquid and the gas with a high concentration of carbon dioxide at an increased pressure when there is a low volume of the gas with a high concentration of carbon dioxide and/or in embodiments where the gas with a high concentration of carbon dioxide comprises at least 50,000 ppm, at least 75,000 ppm, at least 100,000 ppm, at least 150,000 ppm, at least 200,000 ppm, at least 250,000 ppm, at least 300,000 ppm, at least 350,000 ppm or at least 400,000 ppm. The gas with a high concentration of carbon dioxide could have been obtained from degassing an input liquid in a previous step of the method.

In embodiments where the method comprises contacting the input liquid and the gas with a high concentration of carbon dioxide at an increased pressure, the method may comprise subsequently maintaining and storing the input liquid at the high pressure. The method may comprise reducing the pressure of the input liquid to obtain a further gas with a high concentration of carbon dioxide, and using the further gas with a high concentration of carbon dioxide to drive a turbine and thereby generate electricity. The method may comprise reducing the pressure of the input liquid at times of high energy demand. Accordingly, the input liquid could be used to store energy like a compressed air battery.

In embodiments where the method comprises repeated steps of contacting a gas with a high concentration of carbon dioxide and an input liquid, the method may comprise conducting each subsequent step of contacting a gas with a high concentration of carbon dioxide and an input liquid at a higher pressure to the previous step of contacting a gas with a high concentration of carbon dioxide and an input liquid.

For instance, the method may comprise:
contacting a first gas with a high concentration of carbon dioxide and a first input liquid at a first pressure;
degassing the input first liquid to obtain a second gas with a high concentration of carbon dioxide;
contacting the second gas with a high concentration of carbon dioxide and a second input liquid at a second pressure, which is greater than the first pressure; and
degassing the second input liquid to obtain a further gas with a high concentration of carbon dioxide.

Similarly, the method may comprise:
contacting the further gas with a high concentration of carbon dioxide and a further input liquid at a third pressure, which is greater than the first pressure;
degassing the further input liquid to obtain a still further gas with a high concentration of carbon dioxide.

The third pressure may be greater than the second pressure.

A precursor of carbon dioxide may be a carbonate, a bicarbonate and/or carbonic acid. For instance, the carbonate could be sodium carbonate and the bicarbonate could be sodium bicarbonate.

The concentration of carbon dioxide and/or precursors thereof in the input liquid may be at least 1 μmol/kg, at least 10 μmol/kg, at least 50 μmol/kg, at least 100 μmol/kg, at least 500 μmol/kg, at least 1 mmol/kg or at least 1.5 mmol/kg. In some embodiments, the concentration of carbon dioxide and/or precursors thereof in the input liquid may be at least 5 mmol/kg, at least 10 mmol/kg, at least 50 mmol/kg, at least 100 mmol/kg, at least 250 mmol/kg, at least 500 mmol/kg or at least 750 mmol/kg. The concentration of carbon dioxide and/or precursors thereof in the input liquid may be between 1 μmol/kg and 1,000 mmol/kg, between 10 μmol/kg and 100 mmol/kg, between 50 μmol/kg and 50 mmol/kg, between 100 μmol/kg and 25 mmol/kg, between 500 μmol/kg and 10 mmol/kg, between 1 and 5 mmol/kg or between 1.5 and 2.5 mmol/kg. It is noted that the total concentration of carbon dioxide, carbonate ions and bicarbonate ions in seawater is about 2 mmol/kg. Additionally, the solubility of sodium bicarbonate in water at room temperature is about 0.75 to 1.034 mol/kg.

In embodiments where the method comprises contacting the input liquid with a gas with a high concentration of carbon dioxide, the concentrations of carbon dioxide and/or precursors thereof in the input liquid given above may be understood to be the concentration of carbon dioxide and/or precursors thereof prior to the input liquid contacting the gas with a high concentration of carbon dioxide.

The method may comprise degassing the input liquid in a degasser comprising a degassing chamber. The degassing chamber may be a degassing conduit.

In some embodiments, degassing the input liquid to obtain an output gas comprising carbon dioxide may comprise contacting the input liquid with an input gas, and thereby causing carbon dioxide to be transferred from the input liquid to the input gas to produce an output gas, wherein the output gas comprises a higher concentration of carbon dioxide than the input gas.

Accordingly, the method of the first aspect may comprise:
providing an input liquid, wherein the input liquid comprises carbon dioxide, and/or a precursor thereof, dissolved therein;
contacting the input liquid with an input gas, and thereby causing carbon dioxide to be transferred from the input liquid to the input gas to produce an output gas, wherein the output gas comprises a higher concentration of carbon dioxide than the input gas;
capturing the output gas and/or carbon dioxide present in the output gas.

The input gas preferably comprises less than 10,000 ppm carbon dioxide, more preferably less than 1,000 ppm carbon dioxide, less than 800 ppm carbon dioxide, less than 700 ppm carbon dioxide, less than 600 ppm carbon dioxide or less than 500 ppm carbon dioxide, and most preferably comprises less than 450 ppm or less than 430 ppm carbon dioxide. The input gas may comprise between 0 and 1,000 ppm carbon dioxide, between 50 and 1,000 ppm carbon dioxide, between 100 and 800 ppm carbon dioxide, between 200 and 700 ppm carbon dioxide, between 300 and 600 ppm carbon dioxide, between 350 and 500 ppm carbon dioxide, between 400 and 450 ppm carbon dioxide or between 410 and 430 ppm carbon dioxide. In some embodiments, the input gas is atmospheric air.

It is noted that the input gas could be selected to be compatible with a specific membrane or for use with pressure swing adsorption (PSA), to allow concentration of a carbon dioxide gas stream. In some embodiments, the input gas is atmospheric air. In alternative embodiments, the input gas is or comprises nitrogen, helium, methane and/or hydrogen. In some embodiments, the input gas comprises at least 600,000 ppm nitrogen, at least 700,000 ppm nitrogen, at least 750,000 ppm nitrogen, at least 780,000 ppm nitrogen, at least 800,000 ppm nitrogen, at least 900,000 ppm nitrogen, at least 950,000 ppm nitrogen or at least 990,000 nitrogen. It is noted that atmospheric air comprises about 780,840 ppm nitrogen.

Contacting the input liquid and the input gas may comprise bubbling the input gas through the input liquid. The bubbles may have an average diameter of less than 100 cm, less than 50 cm, less than 25 cm, less than 10 cm, less than 5 cm, less than 1 cm, less than 0.8 cm, less than 0.6 cm, less than 0.4 cm, less than 0.2 cm or less than 0.1 cm. In some embodiments, the bubbles may have an average diameter of less than 800 μm, less than 600 μm, less than 400 μm, less than 200 μm or less than 100 μm.

The input liquid and the input gas may be contacted in a batch process. Accordingly, the input liquid may be held in a container when it is contacted with the input gas. The degassing chamber may be or comprise the container.

Alternatively, the input liquid and the input gas may be contacted in a continuous process. Accordingly, the input liquid may be flowing when it is contacted with the input gas. The method may comprise using a pump to cause the cause the input liquid to flow. Alternatively, or additionally, the method may comprise releasing the input liquid from a height to cause it to flow. Alternatively, or additionally, the method may comprise creating a pressure difference to thereby cause the input liquid to flow. For instance, the output liquid may be further contacted with the input gas, thereby reducing the density and the static head of the output liquid and providing motion or flow of the output liquid.

In a preferred embodiment, the method may comprise contacting the input liquid and the input gas while the input liquid is flowing in a first direction. The method may comprise causing contacting the input liquid and the input gas while the input gas is flowing in the first direction. In this embodiment, the flow of the input liquid may be assisted by the flow of the input gas. Alternatively, the method may comprise contacting the input liquid and the input gas while the input gas is flowing in a second direction. The second direction may be opposite to the first direction. The input liquid and the input gas may flow along, and be contacted in, a degassing conduit. The degassing conduit may be a pipe or tube. The degassing chamber may be or comprise the degassing conduit.

In embodiments where the input liquid and the input gas flow in different directions, the method may comprise capturing gas present in the output liquid. The method may comprise combining the output gas and the captured gas.

The method may comprise using a pump to cause the cause the input gas to flow.

In some embodiments, the degassing conduit may be disposed such that a first end thereof is at substantially the same height as a second end thereof. Accordingly, the degassing conduit may be substantially horizontal. The first direction may extend from the first end to the second end. The second direction may extend from the second end to the first end.

Alternatively, the degassing conduit may be disposed such that a first end thereof is higher than a second end thereof. The first direction may extend from the first end to the second end. Accordingly, the input liquid may flow from the first end to the second end. Accordingly, the flow of the input liquid may be assisted by gravity. The second direction may extend from the second end to the first end. Accordingly, the input gas may flow from the second end to the first end. In some embodiments, the degassing conduit may be substantially vertical.

Alternatively, or additionally, degassing the input liquid may comprise subjecting the input liquid to a reduced pressure. The method may comprise subjecting the input liquid to a reduced pressure during a degassing phase.

Subjecting the input liquid to a reduced pressure may comprise creating a pressure differential in the degassing chamber, such that a headspace is at a lower pressure than the input liquid. The headspace may be a portion of the degassing chamber which comprises a gas prior to reduction of pressure. It may be appreciated that as long as the pressure in the headspace is lower than the pressure in the liquid then carbon dioxide may be extracted. If the apparatus is disposed in a body of water, then the input liquid may be pressurized at a pressure greater than atmospheric pressure. Alternatively, input liquid may be pressurized at a pressure greater than atmospheric pressure if the method comprises pressurizing the input liquid, e.g. by contacting it with the gas with a high concentration of carbon dioxide. A skilled person could select a suitable reduced pressure.

The method may comprise applying a pressure reduction system to the input liquid and/or the degassing chamber. The pressure reduction system may create a pressure differential in the vacuum chamber, such that the headspace within the degassing chamber is at a lower pressure than liquid in the degassing chamber.

In some embodiments, applying the pressure reduction system may comprise causing the input liquid to flow through one or more valves configured to reduce the pressure of the input liquid. The one or more valves may comprise a flow control valve, an isolation valve and/or an adjustable pressure relief valve. Alternatively, or additionally, applying the pressure reduction system may comprise using one or more of a vacuum pump, a rotary pump, a diaphragm pump, a liquid ring vacuum pump, a gas transfer pump, a kinetic transfer pump, a positive displacement pump, an entrapment pump, a centrifugal pump and/or an ejector to reduce a pressure in the degassing chamber. Accordingly, the degassing chamber may be a vacuum chamber.

In embodiments where the input liquid is at a pressure greater than atmospheric pressure, the method may comprise reducing the pressure in the degassing chamber, and optionally in the headspace in the degassing chamber, to a pressure which is less than 10 MPa, less than 8 MPa, less than 6 MPa, less than 4 MPa or less than 2 MPa.

The method may comprise reducing the pressure in the degassing chamber, and optionally in the headspace in the degassing chamber, to a pressure which is less than 1 MPa, less than 800 kPa, less than 600 kPa, less than 400 kPa, less than 200 kPa, or less than 101 kPa.

The method may comprise reducing the pressure in the degassing chamber, and optionally in the headspace in the degassing chamber, to a pressure which is less than 150 kPa, less than 125 kPa, less than 101.325 kPa, less than 100 kPa, less than 75 kPa, less than 50 kPa, less than 25 kPa, less than 10 kPa, less than 5 kPa or less than 1 kPa. In some embodiments, the method may comprise reducing the pressure in the degassing chamber, and optionally in the headspace in the degassing chamber, to a pressure which is less than 750 Pa, less than 50 Pa, less than 25 Pa, less than 10 Pa, less than 5 Pa or less than 1 Pa.

Reducing the pressure in the degassing chamber may be understood to mean that the method comprises ensuring at least a portion of the vacuum chamber is at the reduced pressure. Accordingly, the method may create a pressure differential and thereby cause carbon dioxide to be released from the input liquid.

The method may comprise causing the pressure reduction system to continuously act on the degassing chamber during the degassing phase. Alternatively, the method may comprise causing the pressure reduction system to alternatively act on the degassing chamber and not act on the degassing chamber. In some embodiments, the method may comprise alternatively switching the pressure reduction system on and off during the degassing phase. In alternatively embodiments, the method may comprise switching the pressure reduction system to sequentially act on two or more degassing chambers, such that when it is not acting on one degassing chamber it is acting on an alternative degassing chamber.

The method may comprise causing the pressure reduction system to continuously act on the degassing chamber during a pressure reduction period, and to then cause the pressure reduction system to alternatively act on the degassing chamber and not act on the degassing chamber during an extraction period, wherein the extraction period is after the degassing period.

In embodiments and/or periods where the method comprises causing the vacuum to switch between a state where it is acting on the degassing chamber and a state where it is not acting on the degassing chamber, the method may comprise causing the pressure reduction system to act on the degassing chamber for periods of time of at least 10 seconds, at least 20 seconds, at least 30 seconds, at least 40 seconds, at least 50 seconds or at least 1 minute. The method may comprise causing the pressure reduction system to act of the degassing chamber for between 10 seconds and 30 minutes, between 20 seconds and 20 minutes, between 30 seconds and 10 minutes, between 40 seconds and 5 minutes, between 50 seconds and 30 minutes or between 60 and 90 seconds.

In embodiments and/or periods where the method comprises causing the vacuum to switch between a state where it is acting on the degassing chamber and a state where it is not acting on the degassing chamber, the method may comprise causing the pressure reduction system to not act on the degassing chamber for periods of time of at least 1 second, at least 10 seconds, at least 20 seconds, at least 30 seconds, at least 40 seconds, at least 50 seconds or at least 1 minute. The method may comprise causing the pressure reduction system to not act of the degassing chamber for between 1 second and 1 hour, between 10 seconds and 30 minutes, between 20 seconds and 20 minutes, between 30 seconds and 10 minutes, between 40 seconds and 5 minutes, between 50 seconds and 30 minutes or between 60 and 90 seconds.

The method may comprise subjecting the input liquid to a reduced pressure during which in a venting period, the method comprises venting the output gas which is obtained and, in a capture period, which is after the venting period, the method comprises capturing the output gas. The venting period may be directly after the input liquid is subjected to the reduced pressure. Advantageously, venting the gas which is initially produced vents gas with a low concentration of carbon dioxide.

The method may comprise capturing the output gas after the concentration of carbon dioxide rises above a predetermined first concentration. The predetermined first concentration may be a concentration of carbon dioxide of at least 750 ppm, at least 1,000 ppm, at least 5,000 ppm, at least 10,000 ppm, at least 20,000 ppm, at least 30,000 ppm, at least 40,000 ppm or at least 45,000 ppm. In some embodiments, the predetermined first concentration may be a concentration of carbon dioxide of at least 50,000 ppm, at least 75,000 ppm, at least 100,000 ppm, at least 200,000 ppm, at least 300,000 ppm, at least 400,000 ppm, at least 500,000 ppm, at least 600,000 ppm, at least 700,000 ppm, at least 800,000 ppm, at least 900,000 ppm or at least 920,000 ppm.

Alternatively, the method may comprise capturing the output gas after a predetermined first time period. The predetermined first time period may be selected by the skilled person, and may vary depending upon factors such as the volume of liquid and the volume of the degassing chamber. In some embodiments, the predetermined first time period may be between 10 seconds and 30 minutes, between 15 seconds and 10 minutes, between 30 seconds and 5 minutes or between 1 minute and 3 minutes.

The method may comprise stopping degassing the liquid and/or capturing the output gas after the CO₂ concentration in the output gas has dropped below a predetermined second concentration. The predetermined second concentration may be less than 920,000 ppm, less than 900,000 ppm, less than 800,000 ppm, less than 700,000 ppm, less than 600,000 ppm, less than 500,000 ppm, less than 400,000 ppm, less than 300,000 ppm, less than 200,000 ppm, less than 100,000 ppm, less than 75,000 pp or less than 50,000 ppm. In some embodiments, the predetermined second concentration may be less than 45,000 ppm, less than 40,000 ppm, less than 30,000 ppm, less than 20,000 ppm, less than 10,000 ppm, less than 5,000 ppm or less than 750 ppm.

Alternatively, the method may comprise stopping degassing the liquid and/or capturing the output gas after a predetermined second time period. It may be appreciated that the predetermined second time period may vary depending upon various factors including the volume of liquid and the pressure used. The skilled person could select a suitable second time period.

The method may comprise degassing the input liquid in the presence of a solid media. Accordingly, in some embodiments, the input liquid and the input gas may be contacted in the presence of a solid media. Accordingly, the degassing chamber may comprise a solid media. Accordingly, in embodiments where the input liquid and the input gas are contacted in a container or a degassing conduit the solid media may be disposed in the container or the degassing conduit.

The solid media is preferably chemically inert. The solid media may be a porous solid and/or a foamed solid. In some embodiments, the solid material is a porous foamed solid. The solid media may comprise or be a plastic, a ceramic, a metal and/or a rock. In some embodiments, the solid media is or comprises a porous foamed ceramic material. In some embodiments, the solid media is a porous rock, preferably a porous volcanic rock. The solid media may have a surface area of at least 1 m²/g, at least 2 m²/g, at least 5 m²/g, at least 10 m²/g, at least 20 m²/g, at least 30 m²/g, at least 40 m²/l, at least 50 m²/g, at least 75 m²/g, at least 100 m²/g, at least 250 m²/g, at least 500 m²/g, at least 750 m²/g, at least 1,000 m²/g or at least 1,500 m²/g.

The solid media may define a plurality of shapes. The solid media may define a plurality of cylindrical or spherical shapes. The solid media may be randomly orientated in the degassing chamber. Alternatively, or additionally, the solid media may comprise a grid or mesh. The solid media may be configured to disperse the input gas and/or the input liquid and/or slow the flow of the input gas and/or input liquid. Alternatively, or additionally, the solid media may be configured to provide a nucleation site.

In embodiments where the input liquid and the input gas are contacted in a degassing conduit, the conduit may have a length of at least 0.05 m, at least 0.1 m, at least 0.25 m, at least 0.5 m, at least 1 m, at least 2 m, at least 5 m, at least 10 m, at least 25 m, at least 50 m, at least 75 m, at least loom, at least 250 m, at least 500 m, at least 1000 m, at least 5000 m or at least 10,000 m. In some embodiments, for instance, the degassing conduit may extend between the ocean floor and the surface. In some embodiments, the degassing conduit has a length between 0.05 and 2,500 m, between 0.2 and 1,000 m, between 0.4 and 500 m, between 0.5 and 100 m, between 0.6 and 50 m, between 0.7 and 25 m, between 0.8 and 10 m, between 0.9 and 5 m or between 1 and 1.25 m.

The degassing conduit may have an internal diameter of at least 1 mm, at least 5 mm, at least 10 mm, at least 25 mm, at least 50 mm, at least 100 mm, at least 200 mm, at least 300 mm or at least 400 mm. The degassing conduit may have an internal diameter of less than or equal to 100 m, than or equal to 50 m, than or equal to 25 m, than or equal to 15 m, than or equal to 10 m, than or equal to 5 m, than or equal to 2 m, than or equal to 1.5 m, than or equal to 1 m, less than 800 mm or less than 600 mm. The degassing conduit may have an internal diameter of between 1 mm and 100 m, between 2 mm and 50 mm, between 3 mm and 25 m, between 5 mm and 15 m, between 10 mm and 10 m, between 25 mm and 5 m, between 50 mm and 2 m, between 100 mm and 1.5 m, between 200 mm and 1 m, between 300 and 800 mm, between 400 and 600 mm.

The volumetric ratio of the input liquid to the input gas may be between 20:1 and 1:30, between 20:1 and 1:20, between 15:1 and 1:15, between 10:1 and 1:10, between 7:1 and 1:5, between 5:1 and 1:3, between 2:1 and 1:2.5 or between 1:1 and 1:2.

The method may comprise reducing the pH of the input liquid. The pH of the input liquid may be reduced prior to or consecutively with degassing the input liquid. The pH of the input liquid may be reduced prior to or consecutively with contacting the input liquid and input gas. The method may comprise reducing the pH of the input liquid to less than 7, less than 6, less than 5, less than 4 or less than 3.5. The method may comprise reducing the pH of the input liquid to between 0 and 7 or between 1 and 6. In some embodiments, the method comprises reducing the pH of the input liquid to between 2 and 5 or between 3 and 4. The inventors have found that the lower the pH of the input liquid, the high the concentration of carbon dioxide in the output gas. However, in some embodiments it may not be desirable to lower the pH too low as doing so might then mean that the output liquid has to be treated. Accordingly, in alternative embodiments, the method may comprise reducing the pH of the input liquid to between 2 and 6, between 3 and 6, between 4 and 6 or between 5 and 6. Removing carbon dioxide from the input liquid will increase the pH thereof. Accordingly, it may be possible to dispose of the output liquid without the need to adjust the pH thereof.

Alternatively, the method may comprise adjusting the pH of the output liquid. The method may comprise increasing the pH of the output liquid. The method may comprise increasing the pH of the output liquid to at least 4, at least 5, at least 6, at least 7 or at least 7.5. The method may comprise increasing the pH of the output liquid to between 4 and 11, between 5 and 10, between 6 and 9.5, between 6.5 and 9 or between 7 and 8.5. It is noted that the pH of river water generally falls between 6.5 and 8.5, and the pH of seawater is about 8.1.

For the avoidance of doubt, all pH measurements defined herein are taken at 20° C. unless otherwise specified.

Reducing the pH of the input liquid may comprise contacting the input liquid with an acidic species and/or removing an alkaline and/or buffering species from the input liquid. Removing the alkaline and/or buffering species from the input liquid may comprise using an ion exchange resin to capture the alkaline and/or buffering species. The buffering species may be boric acid, a borate, a carbonate, a bicarbonate, a phosphate or a mixture thereof.

Preferably, reducing the pH of the input liquid comprises contacting the input liquid with an acidic species. The acidic species may be a liquid, a solid and/or a gas and/or may be provided as a solution. The acidic species may be or comprise hydrochloric acid, sulphuric acid, nitric acid, acetic acid and/or formic acid. The gas may be or comprise carbon dioxide, a nitrous oxide, a sulfur oxide, hydrogen sulfide, hydrogen chloride, bromide and/or fluoride.

In some embodiments, the sulphuric acid may have been obtained from an exhaust gas, for instance exhaust gas from bunker fuel used on a ship. The sulphuric acid may have been obtained by passing the exhaust gas through a sulphur scrubber. It may be appreciated that sulphur scrubbers are already used to remove sulphur dioxide from exhaust gases on ships. At present, the acid is discharged to the ocean and the pH has to be monitored. However, in the present invention, this waste product could instead be used in the present process.

Alternatively, or additionally, reducing the pH of the input liquid may comprise contacting the input liquid with a chemical waste product produced by a biological process. The chemical waste product may be or comprise a chemical waste product produced by an acid producing and/or alkali depleting species and/or acidic effluent from a species. The acid producing and/or alkali depleting species may be bacteria, algae and/or fungi. The effluent from a species may be from an animal. The animal may be a fish or a bird.

Alternatively, or additionally, reducing the pH of the input liquid may comprise the use of hydrolysis of the input liquid. For instance, the method may comprise passing a sufficient electrical current through the input liquid and separating out and using the acidic stream.

Increasing the pH of the output liquid may comprise diluting the output liquid.

Alternatively, or additionally, increasing the pH of the output liquid may comprise contacting the output liquid with an alkaline species and/or removing an acidic species from the output liquid. Removing the acidic species from the output liquid may comprise using an ion exchange resin to capture the acidic species.

Preferably, increasing the pH of the output liquid comprises contacting the output liquid with an alkaline species. The alkaline species may be a liquid, a solid and/or a gas and/or may be provided as a solution. The alkaline species may be or comprise an amine, ammonia and/or a hydroxide. The amine may be or comprise monoethanolamine, diethanolamine or triethanolamine. The hydroxide may be or comprise ammonium hydroxide, an alkali metal hydroxide and/or an alkaline earth metal hydroxide. The alkali metal hydroxide and/or an alkaline earth metal hydroxide may be or comprise sodium hydroxide, potassium hydroxide, calcium hydroxide and/or magnesium hydroxide.

Alternatively, or additionally, increasing the pH of the output liquid may comprise contacting the output liquid with a chemical waste product produced by a biological process. The chemical waste product may be or comprise a chemical waste product produced by an alkali producing and/or acid depleting species and/or alkaline effluent from a species. The alkali producing and/or acid depleting species may be bacteria, algae and/or fungi. The effluent from a species may be from an animal. The animal may be a fish or a bird.

Alternatively, or additionally, increasing the pH of the output liquid may comprise the use of hydrolysis of the output liquid. For instance, the method may comprise passing a sufficient electrical current through the output liquid and separating out and using the alkaline stream.

The method may comprise heating the input liquid. Alternatively, or additionally, the method may comprise heating input gas. The input liquid and/or input gas may be heated prior to or consecutively with degassing the input liquid. The input liquid and/or input gas may be heated prior to or consecutively with contacting the input liquid and input gas. The method may comprise heating the input liquid and/or input gas to a temperature of at least 5° C., at least 10° C., at least 15° C., at least 20° C., at least 25° C., at least 30° C., at least 35° C., at least 40° C., at least 45° C. or at least 50° C. The method may comprise heating the input liquid and/or input gas to a temperature of between 5 and 100° C., between 1° and 95° C., between 15 and 90° C., between 2° and 85° C., between 25 and 80° C., between 3° and 75° C., between 35 and 70° C., between 4° and 65° C., between 45 and 60° C. or between 5° and 55° C.

The input liquid and/or input gas may be heated using any known means. For instance, the input liquid and/or input gas may be heated using solar energy, infrared radiation, electrical energy, gas, microwave energy, geothermal heating, from hot produced water piped up from the sea floor, from an exothermic chemical reaction and/or via a heat exchange system.

The method may comprise agitating the input liquid. In some embodiments, the method comprises agitating the input liquid while it is being degassed. The method may comprise agitating the input liquid and/or input gas as they are contacted. Agitating the input liquid and/or input gas may comprise using a mechanical mixer, an ultrasonic mixer, one or more baffles and/or porous media. The mechanical mixer may be a stirrer, a propeller or an impellor.

The method may comprise exposing the input liquid to electromagnetic radiation to activate carbon dioxide. The input liquid may be exposed to the electromagnetic radiation before or at the same time as being degassed. The input liquid may be exposed to the electromagnetic radiation before or at the same time as contacting the input gas. The electromagnetic radiation may be infrared light. The electromagnetic radiation may have a wavelength between 500 nm and 1 mm, between 600 nm and 500 μm, between 700 nm and 250 μm, between 800 and 100 μm, between 900 nm and 50 μm, between 1 and 20 μm or between 2 and 15 μm.

The method may comprise reducing the concentration of alkaline components in the input gas. The concentration of alkaline components in the input gas may be reduced prior to contacting the input liquid and input gas.

The method may comprise increasing the concentration of acidic species in the input gas and/or increasing the acidity of the input gas. The concentration of acidic species and/or the acidity of the in the input gas may be increased prior to contacting the input liquid and input gas.

The method may comprise lowering the concentration of carbon dioxide in the input gas. The concentration of carbon dioxide in the input gas may be reduced prior to contacting the input liquid and input gas.

The method may comprise reducing the pressure of the input gas and/or the output gas. The pressure of the input gas may be reduced prior to or consecutively with contacting the input liquid and input gas. The pressure of the output gas may be reduced in an exit stream. The exit stream may be immediately downstream of where the input gas and input liquid contact. The method may comprise reducing the pressure of the input gas and/or output gas to less than 1,000 kPa, less than 800 kPa, less than 600 kPa, less than 400 kPa or less than 200 kPa. In some embodiments, the pressure of the input gas and/or output gas is reduced to less than or equal to atmospheric pressure, i.e. to less than or equal to 101 kPa. In some embodiments, the pressure of the input gas and/or output is reduced to less than 101 kPa.

Capturing the output gas may be understood to comprise preventing the output gas, and/or the carbon dioxide disposed therein, from venting to the atmosphere.

The output gas can be stored or processed further.

For instance, the method may further comprise separating the carbon dioxide from the output gas. Alternatively, if the output gas has a high enough concentration of carbon dioxide (e.g. at least 920,000 ppm) then this may not be required.

Alternatively, or additionally, the method may further comprise contacting the carbon dioxide with an absorbent or adsorbent material and/or a reactive compound.

In some embodiments, the method may comprise separating the carbon dioxide from the output gas and subsequently contacting the carbon dioxide with an adsorbent material and/or reactive compound. In some embodiments, the method may comprise separating the carbon dioxide from the output gas and subsequently storing the carbon dioxide.

In embodiments where the method further comprises separating the carbon dioxide from the output gas, the carbon dioxide may be separated from the output gas using any known techniques. For instance, the carbon dioxide may be separated from the output gas using a membrane, cryogenic separation and/or gas scrubbing with a solvent. The membrane may be a polymeric and/or inorganic membrane. The membrane may be or comprise a size sieving membrane, a surface diffusion membrane, a solution diffusion membrane and/or a facilitated transport membrane. The membrane may be or comprise an alumina membrane, a silica membrane, a carbon membrane, a polyimide membrane, a polyvinyl chloride membrane, a polybenzimidazole membrane, a cellulose acetate membrane, a polyimide membrane, a polysulfone membrane and/or a polycarbonate membrane. Suitable membranes will be known to the skilled person and are described in Han et al. (Journal of Membrane Science, Volume 628, 15 Jun. 2021, 119244) and Iulianelli et al. (Advanced Membrane Science and Technology for Sustainable Energy and Environmental Applications, 2011, 184-213). Cryogenic separation will be known to the skilled person, and is described in Font-Palma et al. (Journal of Carbon Research, 2021, 7, 58). The solvent used for gas scrubbing may react chemically with the carbon dioxide or may physically absorb it. The solvent may be an organic solvent, such as an those containing an alcohol chemical group, an alkane, a carboxylic acid chemical group, an ester chemical group, an aldehyde chemical group, a phosphate chemical group, a phosphate ester chemical group, an ether chemical group, or a molecule or formulation containing any combination of the previously mentioned chemical groups. The alcohol may be methanol. The ester may be propylene carbonate or methyl acetate. The carboxylic acid may be acetic acid. The absorbent or adsorbent material may be or comprise a molecular sieve, an inorganic framework material, an organic framework material, a silica material, activated carbon, an amine, a metal hydroxide and/or an organic solvent. The absorbent or adsorbent material may be a porous material. The porous material may be any suitable porous material. The porous material may be microporous, mesoporous and/or macroporous. It may be understood that a microporous material has an average pore size of less than 2 nm, a mesoporous material has an average pore size between 2 and 50 nm, and a macroporous material has an average pore size of greater than 50 nm. The organic framework material may be a metal organic framework material. The molecular sieve may be a zeolite. The organic solvent may be as defined above. Suitable adsorbent materials are known, for instance see Lai et al. (Greenhouse Gases: Science and Technology, vol. 11(5), pages 1076-1117).

Further processing the output gas may comprise passing the output gas though a gas generator and collecting a carbon dioxide enhanced waste stream. The method may also comprise collecting a carbon dioxide depleted product stream. The carbon dioxide depleted product stream may be used as the input gas. The gas generator may be a nitrogen generator. Nitrogen generators typically take air or contaminated nitrogen gas, purify the nitrogen by passing it through a membrane, employ pressure swing adsorption, or other filters (for example microporous carbon filters), allowing the nitrogen to pass through into a product stream.

Storing the output gas and/or carbon dioxide may comprise pumping the output gas and/or carbon dioxide into an underground reservoir to capture the carbon dioxide therein. Methods to safely store carbon dioxide underground include by are not limited to first mixing it with water (at high carbon dioxide concentrations) and then reacting it with suitable rocks to form a stable carbonate material (e.g. calcite). Alternatively, it may be stored in the form of supercritical carbon dioxide. The supercritical carbon dioxide may be sequestered underground by injection into saline formations, deep unmineable coals seams or enhanced coal bed methane. Storing the output gas and/or carbon dioxide may comprise storing the carbon dioxide or output gas in a depleted oil and gas reservoir.

Alternatively, or additionally, processing the output gas further may comprise reacting the carbon dioxide with another material to produce a commercially usable product and/or combining the method of carbon dioxide extraction described herein with other technologies utilizing large amounts of water based media. Advantageously, the commercially usable product can then be sold, thus reducing the cost and in some cases potentially allowing a profit to be made. Examples of a commercially usable product include a carbonate, syngas, a fuel, a chemical feedstock, an aliphatic polycarbonate, monoethylene glycol, a polyether-polycarbonate polyol, a thermoplastic and a polyhydroxyalkanoate. The carbon dioxide may be reacted by the catalytic conversion of urea, methanol, salicylic acid, cyclic carbonates, dimethyl carbonate, alcohols, olefins, methane, gasoline or another fuel. The carbon dioxide may be reacted with a metal hydroxide to produce a carbonate. The carbonate can then be utilized in the production of cement, as a limestone aggregate for road building, use in the production of iron from iron ore, used in neutralizing acidic soil for agricultural purposes, or used in paper, adhesive, sealants, plastics, rubbers, ceramic tiles and paints as a filler or pigment. The carbon dioxide may be reacted by electrochemical conversion to produce syngas. The syngas may be used as a building block for a synthetic fuel and/or a chemical feedstock. The carbon dioxide may be reacted by photocatalytic and photothermal catalytic conversion to a fuel and/or a chemical feedstock. The carbon dioxide may be reacted by copolymerization of carbon dioxide with another feedstock. The copolymerization may produce an aliphatic polycarbonate, monoethylene glycol, a polyether-polycarbonate polyol, a thermoplastic and/or a polyhydroxyalkanoate.

Alternatively, or additionally, processing the output gas may comprise utilizing the carbon dioxide in a biological process. The biological process may be a process where an enzyme or an organism utilizes the carbon dioxide as a food source. The organism may be a microbe, such as bacteria. The organism may convert the carbon dioxide into an alcohol, syngas, a hydrocarbon or an acid. The alcohol may be ethanol. The acid may be formic acid.

Alternatively, or additionally, the method may comprise compressing the output gas or carbon dioxide to give liquid, solid or supercritical carbon dioxide. The liquid, solid or supercritical carbon dioxide may be used in industry. For instance, liquid carbon dioxide is commonly utilized for the freezing and chilling of food products, carbonation of beverages, water treatment, low temperature testing of aviation and electronic components and/or oil and gas well stimulations. Solid carbon dioxide can be used to freeze foods. Supercritical carbon dioxide can be used to replace other solvents, and/or can be permanently sequestered underground. It has also been suggested that supercritical carbon dioxide can be stored at the bottom of the ocean as “liquid pools” as it is denser than sea water at the low temperatures and high pressure seen in some locations.

In a second aspect, there is provided an apparatus for capturing carbon dioxide, the apparatus comprising:
a degasser, comprising a degassing chamber, a liquid inlet configured to feed an input liquid comprising carbon dioxide, and/or a precursor thereof dissolved therein into the degassing chamber, and a liquid outlet, configured to remove an output liquid from the degassing chamber, wherein the degasser is configured to degas a liquid in the degassing chamber to obtain an output gas comprising carbon dioxide, and the degasser further comprises a gas outlet to remove the output gas from the degassing chamber; and
capture means configures to capture the output gas and/or carbon dioxide disposed therein which flows out of the gas outflow.

The apparatus may be configured to contact the input liquid with a gas with a high concentration of carbon dioxide prior to degassing the input liquid. Accordingly, the apparatus may comprise a contacting chamber configured to contact the input liquid and the gas with a high concentration of carbon dioxide. The contacting chamber may be disposed upstream of the degassing chamber. The contacting chamber may be configured to bubble the gas with the high concentration of carbon dioxide through the input liquid.

The contacting chamber may comprise a liquid inlet, configured to feed the input liquid into the contacting chamber. The contacting chamber may comprise a gas inlet configured to feed the gas with a high concentration of carbon dioxide into the contacting chamber. The contacting chamber may comprise a gas outlet configured to remove a gas from the contacting chamber.

The contacting chamber may be configured to contact the input liquid and the gas with a high concentration of carbon dioxide at an increased pressure. The increased pressure may be as defined above.

The contacting chamber may comprise a contacting conduit.

The contacting conduit may define a high point therein. The gas outlet may be disposed at the high point in the contacting conduit. In embodiments where the contacting chamber comprises a plurality of high points, a gas outlet may be disposed at each high point. Preferably, the gas outlet is disposed downstream of the gas inlet. Preferably, the gas outlet is disposed upstream of the degasser. The terms “downstream” and “upstream” may be understood to refer to downstream and upstream relative to the direction that the input liquid is designed to flow.

The apparatus may comprise one or more valves on the contacting conduit. The one or more valves may be a one way valve, a flow control valve, an isolation valve, adjustable pressure relief valve and/or combinations thereof.

The contacting conduit may be configured to feed the input liquid directly to the degasser, preferably directly to the liquid inlet in the degasser.

Alternatively, the contacting chamber may comprise a separation tank. The separation tank may be disposed downstream of the contacting conduit. The separation tank may be configured to separate the input liquid and undissolved gas. The separation tank may comprise the gas outlet configured to remove undissolved gas from the contacting chamber.

The separation tank may comprise an emergency vent configured to vent a gas in the separation tank if a pressure in the separation tank exceeds a predetermined pressure. The emergency vent may comprise a relief valve.

The apparatus may comprise an input liquid conduit extending between the separation tank and the degasser, and configured to transport the input liquid from the separation tank to the degasser. The apparatus may comprise one or more valves on the input liquid conduit. The one or more valves may be a one way valve, a flow control valve, an isolation valve, adjustable pressure relief valve and/or combinations thereof.

In some embodiments, the apparatus a plurality of degassing chambers. Each degassing chamber may be arranged in series or in parallel.

In embodiments where two or more degassing chamber are arranged in series, the apparatus may be configured to feed the output gas from the gas outlet in a first degassing chamber to a gas inlet in a contacting chamber. The contacting chamber may be as defined above. The apparatus may be configured to feed the input liquid from the contacting chamber into a subsequent degassing chamber. Accordingly, the concentration of carbon dioxide in the output gas may increase with each subsequent degassing chamber.

Accordingly, in some embodiments, the apparatus may comprise:
a first degasser, comprising a degassing chamber, a liquid inlet configured to feed a first input liquid comprising carbon dioxide, and/or a precursor thereof dissolved therein into the degassing chamber, and a liquid outlet, configured to remove a first output liquid from the degassing chamber, wherein the degasser is configured to degas a liquid in the degassing chamber to obtain a first output gas comprising carbon dioxide, and the degasser further comprises a gas outlet to remove the first output gas from the degassing chamber;
a contacting chamber configured to contact a second input liquid and the first output gas therein, wherein the contacting chamber comprises a liquid inlet, configured to feed the second input liquid into the contacting chamber, a gas inlet configured to feed the first output gas into the contacting chamber, a gas outlet configured to remove a gas from the contacting chamber;
a second degasser, comprising a degassing chamber, a liquid inlet configured to feed the second input liquid comprising carbon dioxide, and/or a precursor thereof dissolved therein into the degassing chamber, and a liquid outlet, configured to remove a second output liquid from the degassing chamber, wherein the degasser is configured to degas a liquid in the degassing chamber to obtain a second output gas comprising carbon dioxide, and the degasser further comprises a gas outlet to remove the second output gas from the degassing chamber; and
capture means configures to capture the output gas and/or carbon dioxide disposed therein which flows out of the gas outflow.

The degasser may comprise an emergency vent configured to vent a gas in the degasser if a pressure in the degasser exceeds a predetermined pressure. The emergency vent may comprise a relief valve.

The apparatus may comprise one or more valves on a conduit upstream of the liquid inlet in the degasser. The apparatus may comprise one or more valves on a conduit downstream of the gas outlet in the degasser. The apparatus may comprise one or more valves on a conduit downstream of the liquid outlet in the degasser. In each instance, the one or more valves may be a one way valve, a flow control valve, an isolation valve, adjustable pressure relief valve and/or combinations thereof.

In some embodiments, the degassing chamber comprises or is a processing conduit with first and second ends. In some embodiments, the degasser comprises a gas inlet, configured to feed an input gas into the processing conduit. The gas outlet is preferably configured to remove an output gas from the processing conduit. A gas flow path may be defined in the processing conduit between the gas inlet and the gas outlet.

The apparatus may comprise a gas pump, configured to pump an input gas into the gas inlet.

The liquid inlet may be configured to feed an input liquid into the processing conduit. The liquid outlet may be configured to remove an output liquid from the processing conduit. A liquid flow path may be defined in the processing conduit between the liquid inlet and the liquid outlet, such that at least a portion of the liquid flow path overlaps at least a portion of the gas flow path.

In some embodiments, the apparatus may comprise a plurality of processing conduits. Each processing conduit may comprise a gas inlet, a gas outlet, a liquid inlet and a liquid outlet as defined above. The gas pump may be configured to pump the input gas into the multiple gas inlets of the multiple processing conduits.

Alternatively, or additionally, the degasser may comprise a pressure reduction system, wherein the pressure reduction system is configured to reduce the pressure in the input liquid and/or the degassing chamber and/or create a vacuum in the degassing chamber. In some embodiments, the pressure reduction system may comprise one or more valves configured to reduce the pressure of the input liquid. The one or more valves may comprise a flow control valve, an isolation valve and/or an adjustable pressure relief valve. The one or more valves may be disposed upstream of the degassing chamber. The one or more valves may be disposed downstream of the contacting conduit. Accordingly, the one or more valves may be disposed on a conduit disposed between the contacting conduit and the degassing chamber. Alternatively, or additionally, the pressure reduction system may comprise a vacuum pump, a rotary pump, a diaphragm pump, a liquid ring vacuum pump, a gas transfer pump, a kinetic transfer pump, a positive displacement pump, an entrapment pump, a centrifugal pump and/or an ejector. Accordingly, the degassing chamber may be a vacuum chamber.

The pressure reduction system may be configured to reduce the pressure inside the degassing chamber during a degassing phase. Preferably, the pressure reduction system is configured to reduce the pressure of a headspace in the degassing chamber. The headspace may be a portion of the degassing chamber which comprises a gas prior to reduction of pressure. It may be appreciated that as long as the pressure in the headspace is lower than the pressure in the liquid then carbon dioxide may be extracted.

The pressure reduction system may be configured to create a pressure differential in the vacuum chamber, such that the headspace within the degassing chamber is at a lower pressure than liquid in the degassing chamber. The pressure reduction system may be configured to reduce the pressure of the headspace inside the degassing chamber to a pressure as defined in relation to the first aspect.

The pressure reduction system may be configured to continuously act to reduce the pressure in the degassing chamber during a degassing phase. Alternatively, the pressure reduction system may be configured to alternate between a state where it is acting on the degassing chamber and a state where it is not acting on the degassing chamber during the degassing stage. In some embodiments, when the pressure reduction system is not acting on degassing chamber it is turned off. In alternative embodiments, the apparatus comprises two or more degassing chambers and the pressure reduction system is configured sequentially act on the two or more degassing chambers such that when it is not acting on one degassing chamber it is acting on an alternative degassing chamber.

In some embodiments, the pressure reduction system may be configured to continuously act of the degassing chamber during a pressure reduction period, and to then alternate between a state where it is acting on the degassing chamber and a state where it is not acting on the degassing chamber during an extraction period, wherein the extraction period is after the degassing period.

In embodiments and/or periods where the pressure reduction system is configured to switch between a state where it is acting on the degassing chamber and a state where it is not acting on the degassing chamber, the pressure reduction system may be configured to act on the degassing chamber for periods of time of at least 1 second, at least 10 seconds, at least 20 seconds, at least 30 seconds, at least 40 seconds, at least 50 seconds or at least 1 minute. The pressure reduction system may be configured to act of the degassing chamber for between 1 second and 1 hour, between 10 seconds and 30 minutes, between 20 seconds and 20 minutes, between 30 seconds and 10 minutes, between 40 seconds and 5 minutes, between 50 seconds and 30 minutes or between 60 and 90 seconds.

In embodiments and/or periods where the pressure reduction system is configured to switch between a state where it is acting on the degassing chamber and a state where it is not acting on the degassing chamber, the pressure reduction system may be configured to not act on the degassing chamber for periods of time of at least 10 seconds, at least 20 seconds, at least 30 seconds, at least 40 seconds, at least 50 seconds or at least 1 minute. The pressure reduction system may be configured to act of the degassing chamber for between 10 seconds and 30 minutes, between 20 seconds and 20 minutes, between 30 seconds and 10 minutes, between 40 seconds and 5 minutes, between 50 seconds and 30 minutes or between 60 and 90 seconds.

The apparatus may comprise a vent configured to selectively vent an output gas. The apparatus may be configured to vent the output gas during a venting period in the degassing phase. The apparatus may be configured to capture the output gas during a capture period in the degassing phase which is after the venting period. The venting period may correspond to the pressure reduction period. The capture period may correspond to the extraction period. The venting period may be directly after the pressure reduction system is activated to reduce the pressure inside the degassing chamber. Advantageously, venting the gas which is initially produced vents gas with a low concentration of carbon dioxide.

The apparatus may comprise a CO₂ sensor configured to sense the concentration of the carbon dioxide in the output gas.

The apparatus may be configured to switch to the capture period, and thereby start capturing the output gas, after the CO₂ sensor senses that the concentration of carbon dioxide in the output gas has risen above a predetermined first concentration. The predetermined first concentration may be a concentration of carbon dioxide of at least 750 ppm, at least 1,000 ppm, at least 5,000 ppm, at least 10,000 ppm, at least 20,000 ppm, at least 30,000 ppm, at least 40,000 ppm or at least 45,000 ppm. In some embodiments, the predetermined first concentration may be a concentration of carbon dioxide of at least 50,000 ppm, at least 75,000 ppm, at least 100,000 ppm, at least 200,000 ppm, at least 300,000 ppm, at least 400,000 ppm, at least 500,000 ppm, at least 600,000 ppm, at least 700,000 ppm, at least 800,000 ppm, at least 900,000 ppm or at least 920,000 ppm.

Alternatively, the apparatus may be configured to switch to the capture period, and thereby start capturing the output gas, after a predetermined first time period. The predetermined first time period may be selected by the skilled person, and may vary depending upon factors such as the volume of liquid and the volume of the degassing chamber. In some embodiments, the predetermined first time period may be between 10 seconds and 30 minutes, between 15 seconds and 10 minutes, between 30 seconds and 5 minutes or between 1 minute and 3 minutes.

The apparatus may be configured to turn off the pressure reduction system and/or vent the output gas after the CO₂ sensor senses that concentration of carbon dioxide in the output gas has dropped below a predetermined second concentration. The predetermined second concentration may be less than 920,000 ppm, less than 900,000 ppm, less than 800,000 ppm, less than 700,000 ppm, less than 600,000 ppm, less than 500,000 ppm, less than 400,000 ppm, less than 300,000 ppm, less than 200,000 ppm, less than 100,000 ppm, less than 75,000 pp or less than 50,000 ppm. In some embodiments, the predetermined second concentration may be less than 45,000 ppm, less than 40,000 ppm, less than 30,000 ppm, less than 20,000 ppm, less than 10,000 ppm, less than 5,000 ppm or less than 750 ppm.

Alternatively, the apparatus may be configured to turn off the pressure reduction system and/or vent the output gas after a predetermined second time period. It may be appreciated that the predetermined second time period may vary depending upon various factors including the volume of liquid and the pressure used. The skilled person could select a suitable second time period.

The apparatus may comprise solid media disposed in the degassing chamber. The apparatus may comprise solid media disposed in the processing conduit. The solid media may be as defined in relation to the first aspect.

The processing conduit may have a length of at least 0.05 m, at least 0.1 m, at least 0.25 m, at least 0.5 m, at least 1 m, at least 2 m, at least 5 m, at least 10 m, at least 25 m, at least 50 m, at least 75 m, at least loom, at least 250 m, at least 500 m, at least 1000 m, at least 5000 m or at least 10,000 m. In some embodiments, the processing conduit has a length between 0.05 and 2,500 m, between 0.25 and 1,000 m, between 0.5 and 500 m, between 1 and 100 m, between 2 and 50 m or between 3 and 20 m.

The degassing conduit may have an internal diameter of at least 1 mm, at least 5 mm, at least 10 mm, at least 25 mm, at least 50 mm, at least 100 mm, at least 200 mm, at least 300 mm or at least 400 mm. The degassing conduit may have an internal diameter of less than or equal to 100 m, than or equal to 50 m, than or equal to 25 m, than or equal to 15 m, than or equal to 10 m, than or equal to 5 m, than or equal to 2 m, than or equal to 1.5 m, than or equal to 1 m, less than 800 mm or less than 600 mm. The degassing conduit may have an internal diameter of between 1 mm and 100 m, between 2 mm and 50 mm, between 3 mm and 25 m, between 5 mm and 15 m, between 10 mm and 10 m, between 25 mm and 5 m, between 50 mm and 2 m, between 100 mm and 1.5 m, between 200 mm and 1 m, between 300 and 800 mm, between 400 and 600 mm.

In some embodiments, the apparatus comprises a liquid pump configured to pump an input liquid into the liquid inlet. In embodiments where the apparatus comprises a plurality of degassing chambers, the liquid pump may be configured to pump the input liquid into each liquid inlet. In embodiments where the apparatus comprises a plurality of processing conduits, the liquid pump may be configured to pump the input liquid into each liquid inlet. In alternative embodiments, the apparatus may not comprise a liquid pump.

The processing conduit may comprise a first portion adjacent the first end and a second portion adjacent the second end. The gas inlet may be disposed in the first portion. The gas outlet may be disposed in the second portion. Accordingly, it will be appreciated that in use the gas would flow in a direction from the first end to the second end. In some embodiments, the gas outlet may be disposed substantially adjacent the second end.

In some embodiments, the processing conduit may be disposed or configured to be disposed so that it is substantially horizontal. Alternatively, the processing conduit may be disposed or configured to be disposed so that the first end may be higher than the second end. In a preferred embodiment, the processing conduit may be disposed or configured to be disposed so that the second end is higher than the first end. In some embodiments, the processing conduit is disposed or configured to be disposed in a substantially vertical configuration.

In some embodiments, the liquid inlet may be disposed in the first portion. The liquid outlet may be disposed in the second portion. Accordingly, in use the liquid may flow in the same direction as the gas.

In an alternative embodiment, the liquid inlet may be disposed in the second portion. The liquid inlet may be disposed between the gas outlet and gas inlet. The liquid outlet may be disposed in the first portion. Accordingly, in use the liquid may flow in the opposite direction to the gas. The liquid outlet may be disposed substantially adjacent the second end. The gas inlet may be disposed between the liquid outlet and the liquid inlet.

The degasser and/or the degassing chamber may be configured to be at least partially disposed in a body of water. The processing conduit may be configured to be at least partially disposed in a body of water. Preferably, the first portion of the processing conduit is configured to be disposed in a body of water. In some embodiments, at least a portion of the second portion of the processing conduit is configured to be disposed in a body of water. The liquid inlet may be disposed substantially adjacent to a water level. The gas inlet may be configured to be disposed below a water level.

The body of water may be a pond, lake, reservoir, sea, ocean or any other suitable body of water. The apparatus may be disposed on a structure in the body of water, such as a floating platform or an oil or gas structure. In embodiments, where the apparatus is disposed on an oil or gas structure, it may be possible to convey the output gas and/or the carbon dioxide straight down into abandoned oil wells, thus saving any transport costs. Accordingly, the capture means may comprise means to transport the output gas and/or carbon dioxide to an abandoned oil well.

The apparatus may comprise a gas trap or gas recirculation unit. The gas trap or gas recirculation unit may be configured to separate a gas from the output liquid. The gas trap or gas recirculation unit may comprise a further gas outlet. The further gas outlet may be disposed between the gas inlet and the liquid outlet. The gas trap or gas recirculation unit may comprise a second conduit configured to feed gas from the further gas outlet to the capture means and/or to a location in the processing conduit between the further gas outlet and the first end of the processing conduit. The second conduit may be configured to feed gas from the further gas outlet to the capture means and/or to a location in the processing conduit between the gas inlet and the first end of the processing conduit.

The apparatus may comprise a first pH adjustment means configured to adjust the pH of the input liquid. The first pH adjustment mean may comprise any suitable means, such as those described in relation to the first aspect. Preferably, the first pH adjust means is configured to lower the pH of the input liquid. The first pH adjustment means may be configured to lower the pH of the input liquid to a pH as defined in relation to the first aspect. In one embodiment, the first pH adjustment means may comprise a first injector configured to inject an acid into the input liquid. The first injector may be configured to inject an acid into the input liquid upstream of the liquid inlet and/or into the processing conduit. The first pH adjustment means may comprise a first pH sensor configured to sense the pH of the input liquid. The first pH sensor is preferably disposed downstream of the first injector. The first pH sensor may be disposed in the processing conduit.

The apparatus may comprise a second pH adjustment means configured to adjust the pH of the output liquid. The second pH adjustment mean may comprise any suitable means, such as those described in relation to the first aspect. Preferably, the second pH adjust means is configured to raise the pH of the output liquid. The second pH adjustment means may be configured to raise the pH of the output liquid to a pH as defined in relation to the first aspect. In one embodiment, the second pH adjustment means may comprise a second injector configured to inject an alkaline into the output liquid. The second pH adjustment means may be configured to adjust the pH of the output liquid downstream of the liquid outlet. Accordingly, the second injector may be configured to inject an alkaline into the output liquid downstream of the liquid outlet. The second pH adjustment means may comprise a first pH sensor configured to sense the pH of the output liquid. The second pH sensor is preferably disposed downstream of the second injector.

The apparatus may comprise a heater configured to heat the input liquid and/or input gas. The heater may be configured to heat the input liquid and/or input gas upstream of the liquid inlet and/or the gas inlet. Alternatively, or additionally, the heater may be configured to heat the input liquid and/or input gas in the processing conduit.

The apparatus may comprise an electromagnetic radiation source configured to expose the input liquid to electromagnetic radiation to activate carbon dioxide. The electromagnetic radiation source may be configured to expose the input liquid to electromagnetic radiation upstream of the liquid inlet and/or in the processing conduit. The electromagnetic radiation source configured to expose the input liquid to electromagnetic radiation as defined in relation to the first aspect.

The capture means may be understood to comprise means to prevent the output gas, and/or the carbon dioxide disposed therein, from venting to the atmosphere.

The capture means may comprise a gas store configured to store the output gas and/or the carbon dioxide.

Alternatively, or additionally, the capture means may comprise separation means or a separator configured to separate carbon dioxide from the output gas. The separation means or separator may comprise a membrane a cryogenic separation apparatus and/or a gas scrubbing apparatus. The separation means or separator may be as described in relation to the first aspect.

Alternatively, or additionally, the capture means may comprise an absorbent or adsorbent material and/or a reactive compound. The absorbent or adsorbent material may be as defined in relation to the first aspect.

The capture means may comprise a gas generator. The gas generator may be as defined in relation to the first aspect.

In a further aspect, there is provided an apparatus for capturing carbon dioxide, the apparatus comprising:
a processing conduit with first and second ends;
a gas inlet, configured to feed an input gas into the processing conduit, and a gas outlet, configured to remove an output gas from the processing conduit, wherein a gas flow path is defined in the processing conduit between the gas inlet and the gas outlet;
a gas pump, configured to pump an input gas into the gas inlet;
a liquid inlet, configured to feed an input liquid into the processing conduit, and a liquid outlet, configured to remove an output liquid from the processing conduit, wherein a liquid flow path is defined in the processing conduit between the liquid inlet and the liquid outlet, such that at least a portion of the liquid flow path overlaps at least a portion of the gas flow path; and
capture means configures to capture the output gas and/or carbon dioxide disposed therein which flows out of the gas outflow.

It may be appreciated that any solvents, liquids, and/or formulations used in the apparatus and methods of the invention may be OSPAR compliant for discharge. The OSPAR Convention requires that that registration and hazard assessment is completed on the chemicals used and discharged offshore by the Oil and Gas Industry as well as a process whereby operations permits are issued. The contracting parties to the OSPAR convention regulate the discharge of chemicals and typically require registration data to include information on the chemical composition of the substance/mixture being discharged, as well as information on the biodegradation, bioaccumulation and ecotoxicity of all components which are determined using internationally accredited test methods such as those published by the Organization for Economic Cooperation and Development (OECD), International Organization for Standardization (ISO), ASTM International (ASTM), and OSPAR Commission (PARCOM). Any solvents, liquids and/or formulations may also be compliant with other discharge regulations across the worldwide known to those skilled in the art including but not limited to the NDPES General Permit for discharge to the Gulf Of Mexico. Additionally, specific regulations relating to Carbon Capture and Storage are in place around the world and will be known to those skilled in the art.

All features described herein (including any accompanying claims, abstract and drawings), and/or all of the steps of any method or process so disclosed, may be combined with other technologies utilizing water based media to reduce the costs of the technologies. For instance, combining the methods and processes of carbon dioxide described herein with desalination of sea water, the treatment of fresh water, the treatment of sewage, the transport of water over large distances via pipelines, the generation of electricity were water based media are flowed through an electricity generating device.

All features described herein (including any accompanying claims, abstract and drawings), and/or all of the steps of any method or process so disclosed, may be combined with any of the above aspects in any combination, except combinations where at least some of such features and/or steps are mutually exclusive.

For a better understanding of the invention, and to show how embodiments of the same may be carried into effect, reference will now be made, by way of example, to the accompanying Figures, in which:—

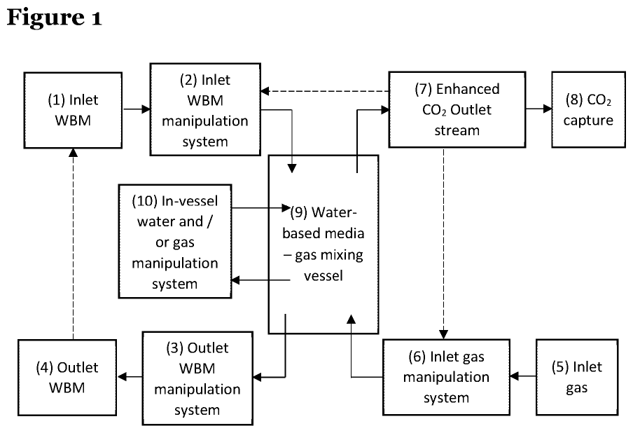

FIG. 1 is a schematic overview of a system for extracting carbon dioxide from a liquid;

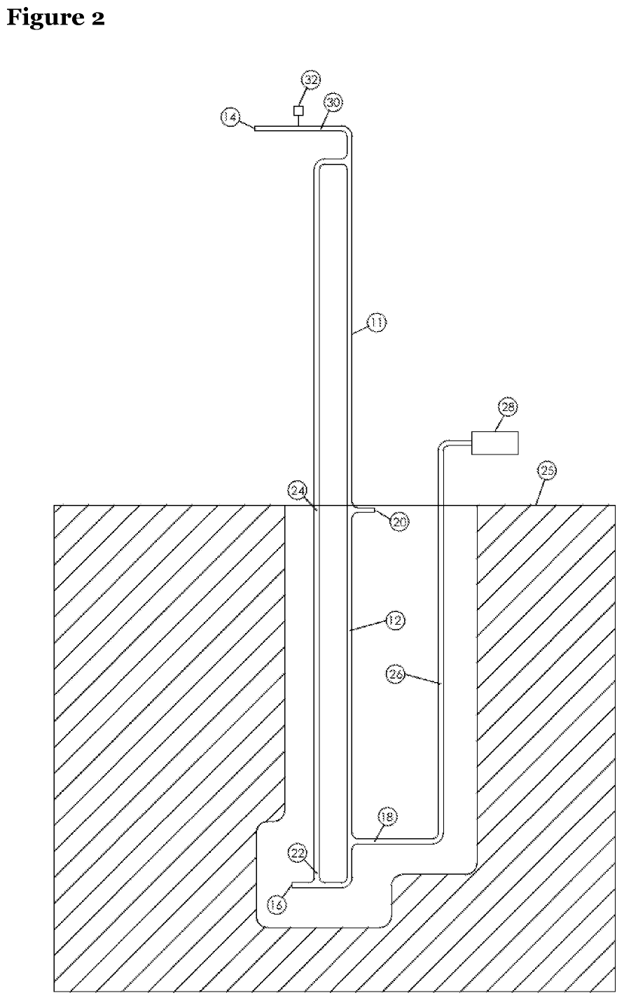

FIG. 2 shows an apparatus used in accordance with the invention;

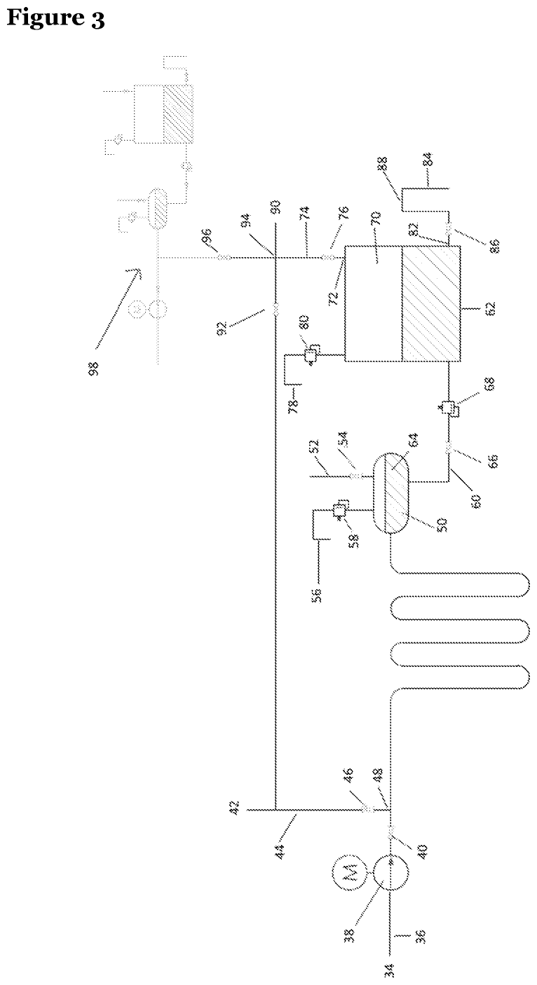

FIG. 3 is a schematic diagram of a further system for extracting carbon dioxide from a liquid;

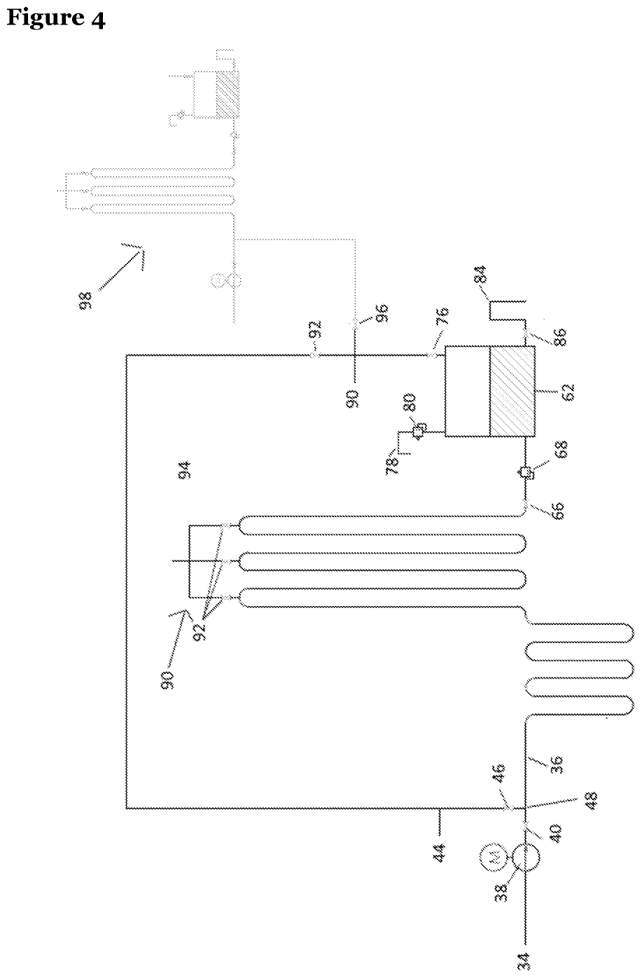

FIG. 4 is a schematic diagram of a further system for extracting carbon dioxide from a liquid;

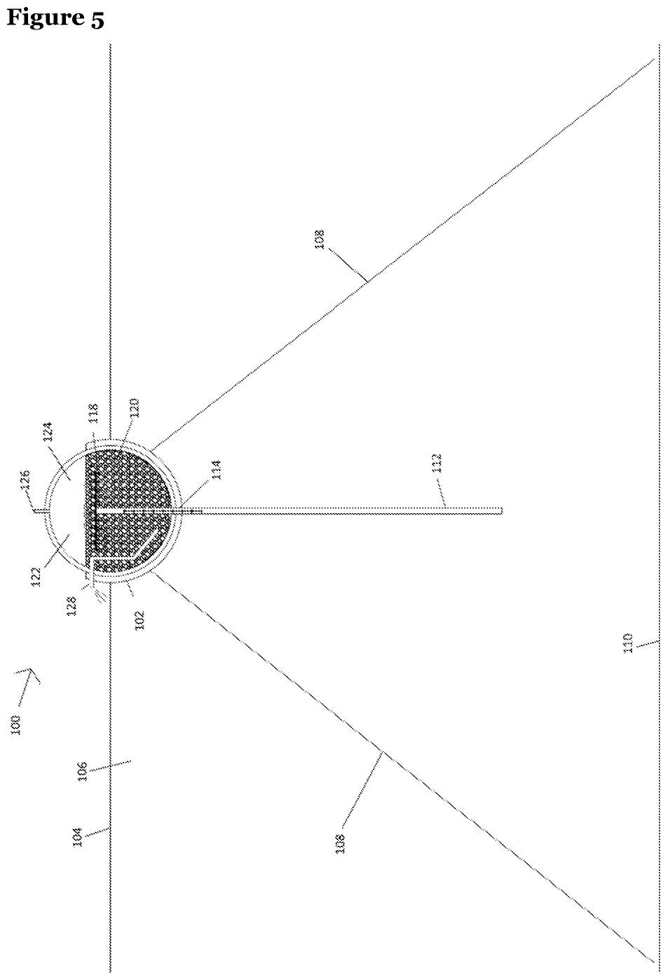

FIG. 5 shows a buoyant vacuum extraction system of the present invention; and

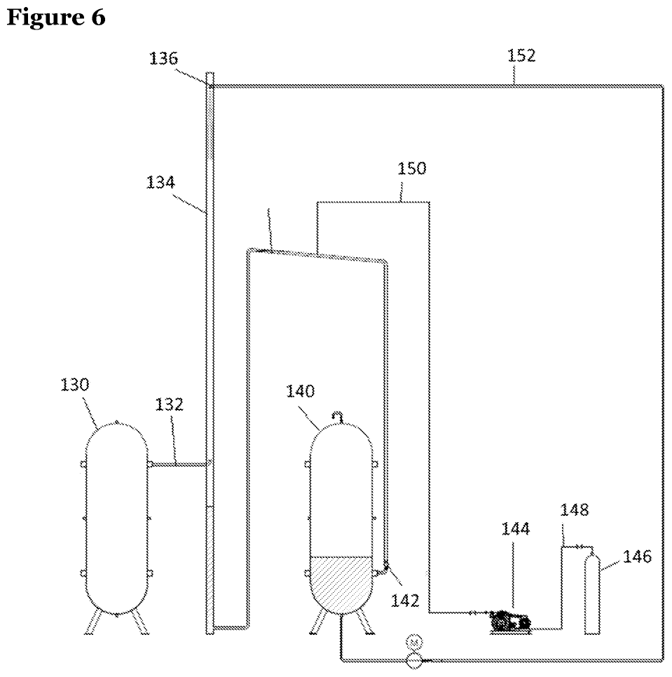

FIG. 6 is a schematic diagram of a still further system for extracting carbon dioxide from a liquid.

FIG. 1 shows a schematic diagram of a system for extracting carbon dioxide from a liquid. In the system shown in FIG. 1 the liquid is a water based medium (WBM). The WBM comprises carbon dioxide, and/or a precursor thereof, dissolved therein. It will be appreciated that an aqueous solution may be used as the WBM. This includes, but is not limited to, fresh water, seawater, produced water, brackish water, wastewater, rainwater, sewerage water, deionized water and water containing brines.

The WBM is pumped, or otherwise flows, through a WBM inlet 1. The WBM can flow directly into a WBM/gas mixing vessel 9. However, in the illustrated embodiment, the WBM first flows into an inlet WBM manipulation system 2. The inlet WBM manipulation system 2 is configured to manipulate the chemical or physical properties of the WBM. For instance, the inlet WBM manipulation system 2 may be configured to modify the pH and/or temperature of the WBM. After any modification has been achieved, the WBM is pumped, or otherwise flows, into the WBM/gas mixing vessel 9. In a preferred embodiment, as shown in FIG. 1, the WBM preferably flows into a first end of the WBM/gas mixing vessel 9.

Concurrently, an input gas is pumped, or otherwise flows, through a gas inlet 5. The gas can also flow directly into a WBM/gas mixing vessel 9. However, in the illustrated embodiment, the gas first flows into an input gas manipulation system 6. The input gas manipulation system 6 is configured to manipulate the chemical or physical properties of the input gas. For instance, the input gas manipulation system 6 may be configured to modify the composition and/or temperature of the input gas. After any modification has been achieved, the input gas is pumped, or otherwise flows, into the WBM/gas mixing vessel 9. In a preferred embodiment, as shown in FIG. 1, the input gas preferably flows into a second end of the WBM/gas mixing vessel 9. In a preferred embodiment, the second end is opposite and at a lower height to the first end. This has the advantage that the WBM flows from the first end to the second end due to gravity acting thereon, and the input gas will travel in the opposite direction, bubbling through the WBM. This will cause carbon dioxide present in the WBM to be transferred to the input gas.

The system may comprise an in-vessel manipulation system 10, configured to manipulate the chemical or physical properties of the WBM and/or the gas which is present in the WBM/gas mixing vessel 9. The in-vessel manipulation system 10 may modify the properties of the WBM and/or the gas similarly to the input WBM and/or gas manipulation systems 2, 6 described above.

The gas, comprising an increased concentration of carbon dioxide, is then pumped, or otherwise flows out of the WBM/gas mixing vessel 9. In a preferred embodiment, the gas preferably flows out of the first end of the WBM/gas mixing vessel 9. Since the gas contains a high concentration of carbon dioxide, it can then stored or further processed using any carbon capture techniques. Due to the high concentration of the carbon dioxide, these techniques can be used much more efficiently than would be possible using gas from the atmosphere.

Meanwhile, the WBM, comprising a reduced concentration of carbon dioxide, is also pumped, or otherwise flows out of the WBM/gas mixing vessel 9. In a preferred embodiment, the WBM preferably flows out of the second end of the WBM/gas mixing vessel 9. The WBM may flow directly out of an outlet 4. The WBM could be disposed of, for instance by returning it to the environment.

However, in the embodiment illustrated, the WBM first flows through an outlet WBM manipulation system 3. The outlet WBM manipulation system 3 is configured to manipulate the chemical or physical properties of the WBM. For instance, the outlet WBM manipulation system 2 may be configured to modify the pH of the WBM. This may ensure that the WBM can be returned to the environment without the risk of harm. After any modification has been achieved, the WBM is pumped, or otherwise flows, out of the outlet 4.

### EXAMPLES

### Example 1—Aerating Water to Extract Carbon Dioxide in a Small Scale Batch Test

A system to increase the CO₂ content of water-based media was set up utilizing a vertical clear pipe which had a 40 mm outside diameter and a 34 mm inside diameter. The pipe was approximately 1 m long. The pipe was packed with elongate plastic media. The plastic media defined a hollow cylindrical shape open at one end and with slots down the sides thereof (70 mm long, 17 mm outer diameter, 8-12 mm inner diameter). The pipe contained a total of 1 L of water-based media, which was either tap water or sea water. A variable speed airflow (0-16 Liters per minute) was connected to a 12.5 mm diameter aperture near the bottom of the pipe, and exhaust gas was emitted through a further 12.5 mm diameter aperture near the top of the pipe. The exhaust gas flow was then passed over a calibrated 0-10,000 ppm CO₂ sensor, which measured the CO₂ level every 2 seconds. At the start of each test, a known quantity of hydrochloric acid was added to the water column. The results are shown in Table 1.

TABLE 1
Maximum CO₂ measured in exhaust gas stream after
contacting water based medium at varying pHs

| | pH after | Maximum CO₂ in | |
|---|---|---|---|
| Water | HCl | exhausted | |
| Type | adjustment | stream | |
| Fresh | 8.0 | ≤1000 | ppm |
| Fresh | 6.5 | 5-10,000 | ppm |
| Fresh | 6.3 | >10,000 | ppm |
| Fresh | 4.6 | >10,000 | ppm |
| Fresh | 3.5 | >10,000 | ppm |
| Sea water | 5.8 | 5-10,000 | ppm |
| Sea water | 3.1 | >10,000 | ppm |

The inventors were surprised to note the high concentration of CO₂ omitted in some of the experiments. In particular, in four of the experiments detailed above, the concentration of CO₂ exceeded the maximum concentration detectable by the sensor. While the inventors noted that further tests were needed, they noted that they were able to extract CO₂ from both fresh and sea water. They also noted that the concentration of CO₂ extracted from the water appeared to increase as the pH of the water decreased.

### Example 2—Aerating Water to Extract Carbon Dioxide in a Continuous Test

A system similar to that in example 1 was set up. This system comprised a wider diameter pipe (265 mm outside diameter, 225 mm internal diameter) with a maximum useable internal height of the pipe was 2.7 meters. The pipe was again packed with plastic media, as described above. A water inlet 2.3 meters above the bottom of the pipe was connected to mains tap water, which typically flows at a rate of 4 to 6 Liters per minute. A water outlet was provided near the base of the pipe. An air pump rated at 55 Liters per minute was connected to an aperture near the base of the pipe, and a gas outlet was provided near the top of the pipe, and the exhaust gas flow was then passed over a 0-100,000 ppm CO₂ sensor which measured the CO₂ level every 2 seconds. A variable concentration acid dosing system was also provided, which added diluted HCl to the incoming water stream. The amount of HCl added to the water stream was increased as the experiment progressed. The resultant pH of the water was measured at the water outlet at various CO₂ emission levels. The results are shown in Table 2.

TABLE 2
pH of water measured when various CO₂ concentrations
where detected in exhaust gas stream

| CO₂ in exhaust | pH of treated |
|---|---|
| gas stream | tap water |
| ≤2,000 ppm | 8.0 |
| 10,000 ppm | 6.7 |
| 20,000 ppm | 6.0 |
| 30,000 ppm | 5.9 |
| 40,000 ppm | 5.8 |
| 46,000 ppm | 5.7 |

The inventors again noted that the concentration of CO₂ present in the exhaust gas stream increased as the pH of the water decreased. The inventors were surprised to be able to obtain a maximum concentration of 46,000 ppm in these experiments. This is an increase in concentration by over two orders of magnitude.

### Example 3—Aerating Water to Extract Carbon Dioxide in a Further Continuous Test

A system similar to example 1 was set up. However, in this system the pipes had differing heights. In each experiment, the column was a clear pipe with a 40 mm outside diameter and 34 mm inside diameter, and was packed with porous plastic media (70 mm long, 17 mm outer diameter, 8-12 mm inner diameter). A variable speed airflow (0-7 Liters per minute) was passed through 12.5 mm diameter aperture near the bottom of the tube. The input gas flow rate was kept constant at about 7 liters per minute. Exhaust gas was emitted through a further 12.5 mm diameter aperture near the top of the pipe. The exhaust gas flow was passed over a calibrated 0-10,000 ppm CO₂ sensor, which measured the CO₂ level every 2 seconds. In each test the water flow remained constant. The pH of the water was not adjusted in this experiment. The results are provided in Table 3.

TABLE 3
CO₂ concentrations detected in exhaust
gas stream for different column heights

| Column | CO₂ in exhausted |
|---|---|
| Height/meters | stream |
| 0.25 | 1200 ppm |
| 0.5 | 1300 ppm |
| 1 | 1400 ppm |
| 2 | 1750 ppm |

The inventors noted that the concentration of CO₂ in the exhaust gas increased as the column height increased.

### Example 4—Aerating Water Taken from a Large Body of Water in a Continuous Test

The inventors subsequently investigated using the system in a larger body of water. The apparatus used is shown in FIG. 2.

Briefly, the apparatus 11 comprises a first conduit 12, extending between a first end 14 and a second end 16. An air inlet 18 is disposed closer to the second end 16 than the first end 14. A water inlet 20 is disposed between the air inlet 18 and first end 14. The first end 14 comprises a gas outlet and the second end 16 comprises a water outlet. A recirculation unit comprises a gas outlet 22, disposed between the air inlet 18 and the second end 16, and a second conduit 24 extending between the gas outlet 22 and a point between the water inlet 20 and the first end 14. A valve (not shown) was disposed in the second conduit. The inventors ran some experiments with the valve open, and some with it closed.

FIG. 2 shows the apparatus 11 in situ in a body of water 25. In the image, the body of water 25 is a pond. However, it will be appreciated that the apparatus could be disposed in any suitable body of water, such as a reservoir, a lake, the sea or the ocean. The first conduit 12 is substantially vertical with the first end 14 disposed above the water 25 and the second end 16 disposed below the water 25. The water inlet 20 was disposed at, or marginally below the water line. A third conduit 26 extends between an air pump 28 and the air inlet 18. The air pump 28 could provide air at a flow rate of up to 55 l/minute. A fourth conduit (not shown) extends between the body of water and the water inlet 20. A water pump (not shown) is disposed on the fourth conduit and can pump water at a flow rate of up to 15 l/minute. Finally, a fifth conduit 30 extends between the first end 14 and a CO₂ sensor 32.

The experiments conducted by the inventors are summarized in the table below.

TABLE 4
Summary of experiments conducted by the
inventors in a large body of water

| Flow rate | Flow rate | Valve in second | CO₂ in |
|---|---|---|---|
| of air | of water | conduit | exhausted |
| l/min | l/min | open? | stream/ppm |
| 55 | 15 | No | 1500 |
| 55 | 15 | Yes | 1450 |
| 27.5 | 15 | Yes | 1850 |
| 27.5 | 15 | No | 1850 |
| 55 | 7.5 | Yes | 1360 |
| 27.5 | 7.5 | Yes | 1600 |

The inventors note that the gas trap captures which would otherwise escape in the water stream.

The inventors were also pleased to note that they could obtain relatively high CO₂ concentrations on this large scale. While the inventors did not adjust the pH of the water in this experiment, they note that this could be done in later trials and they would then expect similar results to those seen in example 2.

After the above tests, the inventors switched the water off and run the air on its own with what water was in the tube. The air coming up the tube also caused a steady stream of water to come out the side entrance. The flow was strong, and suggests that it might be possible to design systems which only require an air pump, with no water pump being required.

### Example 5—Aerating Water to Extract Carbon Dioxide in a Large Batch Test

The inventors then decided to test a large scale batch setup.

In this test, the used a cylindrical test chamber purpose built from a section of corrugated tubing with an internal diameter of 225 mm, suitably sealed at each end using drainage pressure test plugs. The height of water within the test vessel could be selected at between 0-2 meters. In the tests described below, a water height of 1.25 m, resulting in a water volume of 50 l, was used. Testing was conducted at ambient temperature and pressure. The chamber was filled with test golf balls, which provided additional surface area and were a means to avoid air pockets forming in the system.

It will be appreciated that various air pumps could be utilized and, in the tests outlined below, a Charles Austen Pumps Ltd Model E100 air pump was used which provides a maximum of 100 l/min, resulting in an output at the exit port from the system of 80 l/min of air as measured using a Nixon Flow Meter. It was this air speed which was used in the tests described below. The exit gas was passed over a sensair K33 ICB sensor which gave an output in ppm, measured every 2 seconds using the Gaslab software. This output was produced in the form of both a graph and as raw data.

Air could be added via up to 3 available entry points provided adjacent to the base of the chamber, and utilized a range of potential air stones disposed in the base of the chamber to diffuse the input gas within the input liquid. In the testing described below, air was added via all three entry points.

The water was added to the chamber using a standard diaphragm pump, but any suitable pump could be used. In the field, it is envisaged that the requirement to pump the fluid into the chamber may be avoided by using gas lift i.e. by pumping air through the capture apparatus while it is submerged in water and using the increased buoyancy to replace the air in the apparatus chamber, as described in example 4.

Details of two tests are provided in Table 5, below. It is noted that in small scale tests using seawater from Wormit Bay gave similar results to tap water. Accordingly, for logistical reasons, tap water was used for these large scale tests, but the results would also apply to the use of seawater. In the first test, hydrochloric acid was added to the tap water prior to the test, to modify the pH to 5.5 at room temperature. In the second test, no acid was added to the water, it is noted that the pH of the tap water was 8.2 at room temperature.

TABLE 5
Summary of large scale batch experiments
conducted by the inventors

| | Test 1 - | Test 2 - |
|---|---|---|
| | HCl added to | No acid |
| | the water | added |
| Test duration (s) | 268 | 295 |
| Volumetric ratio of air to water | 1:7.15 | 1:7.87 |
| Average ppm of CO₂ | 7541 | 732 |
| Total litres of CO₂ obtained | 2.69 | 0.29 |
| Total grams of CO₂ obtained | 5.38 | 0.58 |
| Grams CO₂/litre of water (g/l) | 0.11 | 0.01 |
| Projected volume of CO₂ from 1 | 107.5 | 11.5 |
| billion litres of water (tonnes) | | |

Test 1 demonstrates that obtaining an average of 100 tonnes of CO₂ per billion litres of water while using acid is achievable. As demonstrated by test 2, when no acid is used, a lesser average of around 10 tonnes of CO₂ is achievable. This confirms that it is desirable to use acid, where possible, to increase yields.

It is also noted that for Test 1, the pH at the end of the test was 7.6 at room temperature.

### Example 6—Applying a Vacuum to Extract Carbon Dioxide from Water

The inventors then decided to investigate the possibility of degassing water using a vacuum.

The following equipment was used:
A small scale vacuum chamber—typically a BACOENG 12 L (25 cm×25 cm) with 30″ Hg±1 Max Reading pressure gauge and manifold;
A vacuum pump, in the experiments described below a VEVOR 10 CFM, 1 HP 2 stage rotary vane vacuum pump was used. The vacuum pump was attached to the vacuum chamber via a ¼″ vacuum hose with ¼″ SAE Fittings;
A high end CO₂ sensor, in the experiments described below a 0-300,000 ppm sensair K33 ICB with top hats was used;
A low end CO₂ sensor, in the experiments described below a Sensair K30 10,000 ppm model was used;
Gaslab Software was used for reading CO2 sensors;
Hitop ‘shark’ 6.9 litre per minute (max) air pump; and
500 ml Schott bottles and connecting hose.

A vacuum was applied to the test chamber at as high a vacuum as possible containing tap water acidified with HCl, at a pH of 5.5, and various tests were conducted, as described below.

### Determination of CO₂ Remaining

A simple test was utilised to determine the amount of CO₂ remaining in the water after each vacuum test. This involved taking 500 ml of the test fluid from the chamber before and after the test and bubbling air through it with the Hitop ‘shark’ 6.9 litre per minute (max) air pump to establish the amount of CO2 released.

A typical result for the acidified tap water pre-vacuum was a maximum height reached of approximately 9,000 ppm-10,000 ppm on the K30 1% senseair CO₂ unit. A typical result after a vacuum had been applied ranged between 1,500 ppm and about 3,000 ppm, depending on a variety of factors. A maximum height of around 2,000 ppm was considered a good result. In general, a finding of 70-85% removal of CO₂ in comparison to air treatment was considered acceptable.

While the amount of CO₂ released from the water was less than the amount obtained when treated with air, as described above, there will be a cut-off point where air is no longer viable. This is because removal of all CO₂ will not be practically viable at a point as the ppm recovery rate will be too low. In addition, when a vacuum is used, it is envisaged that in some cases it may be desirable to end the treatment process by blowing air through the water to re-aerate and oxygenate it prior to return to the environment. When considering these two factors, 70-85% efficiency when compared to the aeration method is considered a good result for vacuum.

### Nucleation Material and Stirring

Various nucleation materials were trialed with a particular focus on biomedia including lava rocks, Oase Hel-X13, XX1000, bio balls, ceramic rings, ceramic balls, alfagrog, plastic golf balls etc.

With no media present the production rates for the output gas stream comprising CO₂ were poor whilst all of the above media performed to some degree or other with overall lava rocks and/or Alfagrog (a porous foamed ceramic material) utilised as the best option for this testing.

Agitation was also trialed and did add to the results but not as well as the nucleation material. However, it was found that stirring (in this case with a magnetic stirrer bar at the bottom of the 12 l vessel), increased the mixing of the layers of fluid within the vessel making for a more uniform result throughout the fluid (without stirring a slightly different result could be gained from top and bottom of the vessel and this variation increased with deeper test vessels such as a 25×38 cm vessel).

### Timing

In their experiments, the inventors found that it took in the region of 1-1.5 minutes to achieve full vacuum and another 3.5-5 minutes to remove a significant amount of CO₂. There are a number of scenarios to consider but overall it is felt that in this particular test 5-10 minutes in total (7 a good median) was a fairly acceptable balance for removal of 70-80% of available CO₂ in a 12 l chamber. Although, in some tests, it could take up to 15 minutes for readings to peak on the exit tube, and up to another 15 minutes for readings to come down again (see “Capturing the CO₂ Stream” section below).

### Chamber Volume

The more water present, the quicker a full vacuum could be achieved, and the higher the CO₂ ppm stream. However, issues were observed with water entering the oil chamber of the vacuum pump, so some headspace was typically left. In most cases, a head space of approximately 4.5 litres were found to be optimum.

### Maintenance of Vacuum

The inventors investigated a number of ways of using a vacuum pump, and analysed the amount of CO₂ left in the water after each run, as described above.

In particular, it was found that results were similar for a run where the vacuum pump was left on for 7-10 minutes compared to a run where the vacuum pump was on until it reached full vacuum (approx. 1.5-2 mins) and then alternated on and off every minute. Conversely, a similar test alternating every 15 seconds did not yield as good a result. Another test which applied the vacuum pump for 1-2 minutes and was then turned off and left overnight gave a very good result.

It is noted that testing mainly focused on using a constant vacuum for simplicity. However, it is clear that there is scope to significantly lower the amount of energy input required by selectively turning the vacuum on and off. Alternatively, or additionally, one vacuum pump could be used to maintain a reduced pressure in several different vacuum chambers at once.

### Capturing the CO₂ Stream

The inventors noted that when they applied a vacuum to an optimised system using tap water, as described above, in some instances a peak reading of 120,000 ppm CO₂ in the captured gas could be obtained. It is noted that t did take about 15 minutes for the reading at the sensor to peak. The inventors believe that this is due to the slow rate of transfer of the gas from the chamber to the sensor.

The inventors believe that, when the vacuum pump is applied, first the air is evacuated from the chamber to produce a vacuum. Once this is achieved the gases contained in the water phase begin to be extracted. It is therefore likely that the gas being evolved will have a very high percentage of CO₂ (potentially >85%). This is because the inventors are attempting to convert stored carbonates to CO₂ gas.

In a bid to establish if the above hypothesis was correct, an experiment was designed which used two identical 12 litre vacuum chambers. A first vacuum pump was connected via a hose to a first valve disposed on a lid. The lid was located on the first chamber. The first valve was opened and the vacuum pump switched on. Output gas extracted by the first vacuum pump was analysed using a CO₂ sensor, and when a reading of 120,000 ppm CO₂ was observed the first valve was closed and the vacuum pump was left running. This ensured that the air had been evacuated in the hose which extended between the first valve and the first vacuum pump.

While leaving the first vacuum pump running and the first valve closed, the lid was moved to the second 12 litre vacuum chamber. Once the lid was in place, the second vacuum chamber was evacuated using a second vacuum pump which was connected to a second valve in the lid. Once the second vacuum chamber had been evacuated, the second valve was closed and the second vacuum pump was turned off.

This in effect allowed for the testing of second vacuum chamber to commence, by opening the first valve, without any evacuated air being present. In other words, no extra air was introduced when switching from the first vacuum chamber to the second vacuum chamber.

When the first valve was opened, and testing of the output gas from the second chamber commenced, the concentration of carbon dioxide in the output gas dropped only slightly, and the concentration of carbon dioxide continued to climb to reach 180,000 ppm after 15 minutes. The above procedure was repeated, and the concentration of carbon dioxide climbed to 280,000 ppm prior to stopping test at the end of its 15 minute run.

The inventors have therefore demonstrated that it is possible to obtain a very high concentration of CO₂ by excluding air from the test apparatus.

### Example 7—Investigating the Effect Temperature has on Recovery Rates

4.5 litres of Wormit Bay Seawater treated with 4 ml of 10% HCl was utilised in this test. The test method and equipment were as described above, in example 6, and the vacuum pump was run continuously for a total of 7 minutes. Four separate test temperatures were compared and tested and the resultant fluid captured and stored until all four samples reached the same temperature.

Once temperature parity had been reached, the four samples were aerated to establish a CO₂ peak, and thereby establish how much CO₂ was retained in the water, in a bid to determine the effects of lowering temperature on recovery rates.

TABLE 6
Results showing how the amount of
CO₂ extracted varied with temperature

| Temp. in Chamber | Initial | CO₂ remaining |
|---|---|---|
| (° C.) | pH | (peak ppm) |
| 16.2 | 3.13 | 2,930 |
| 13.3 | 3.14 | 2,812 |
| 10.0 | 3.19 | 3,320 |
| 4.0 | 3.16 | 3,000 |

It is noted that no clear trend was observed, and the results seemed variable within a small band. The highest and lowest results were within 4% of each other.

However, the inventors note that, in light of the above results, it appears that any effect temperature has on the ability to extract CO₂ is likely to be minimal within these ranges. Accordingly, it is thought that the methods of extracting CO₂ developed by the inventors can be used effectively at low temperatures, for instance to extract CO₂ from cold seawater.

### Example 8—Comparison of Tap and Seawater

The experiments described below compare seawater from Wormit bay and fresh Balmerino tap water under near identical test conditions. In both cases, the water was treated with HCl to obtain a pH of 5.5.

Carbon dioxide was extracted using a vacuum pump, as described in example 6. In each test 4.5 l of test fluid was provided in a 12 l test vessel, with lava rock nucleation material. Test fluid was approximately 10 cm from the top of vessel. A small magnetic stirrer bar was operational at the bottom of the vessel to help mix the fluid layers. Tests were run for 7 and 15 minutes.

For the tests which were conducted over 15 minutes, the peak level of CO₂ exiting the chamber was measured using the high end sensor. After each test, 500 ml of test fluid was aerated and the peak level of CO₂ was measured using the low end sensor. A sample of the tap water and seawater, which had been treated with HCl to a pH of 5.5, but had not undergone vacuum, was also aerated. It is noted that the peak level of CO₂ measured for the untreated tap water was 9,000 ppm, and for the untreated seawater it was 6,500 ppm. These values were used to estimate the percentage of carbon dioxide removed during the vacuum extraction process.

The results are provided in the table below.

TABLE 7
Results comparing the different amount of carbon
dioxide extracted from tap water and sea water

| | Tap Water | | Seawater | |
|---|---|---|---|---|
| | After 7 | After 15 | After 7 | After 15 |
| | minutes of | minutes of | minutes of | minutes of |
| | applied | applied | applied | applied |
| | vacuum | vacuum | vacuum | vacuum |
| pH of liquid | 6.5 | 6.7 | 6.4 | 6.5 |
| Peak level of CO₂ | Not | 91,000 | Not | 65,000 |
| exiting the | measured | | measured | |
| chamber (ppm) | | | | |
| Peak level of CO₂ | 1,900 | 1,600 | 1,600 | 1,400 |
| obtained from | | | | |
| evacuated test | | | | |
| fluid (ppm) | | | | |
| Percentage of | 79 | 83 | 75 | 79 |
| carbon dioxide | | | | |
| removed (%) | | | | |

It is noted that less carbon dioxide was obtained for the sea water compared to the tap water. However, it is noted that the seawater contained a lower concentration of carbon dioxide. This would be expected to vary between samples. The percentage of carbon dioxide removed from both the tap water and seawater was broadly similar.

### Example 9—Large Scale Vacuum Extraction

Further to the testing described above, a larger 76 litre chamber was sourced from Island Scientific Ltd with dimensions 46 cm×46 cm. The same vacuum pump (Vevor 10 CFM) was used and the same style of vacuum gauge although the pipework to the vacuum chamber was upgraded to ½″ BSP.

Lava rocks were used, approximately 40 litres of acidified tap water to pH 5.5 with HCl were added to the chamber.

Results obtained were similar to the 12 l chamber in terms of amounts evacuated (70-80%) and timing to evacuate (5-10 mins, 7 median). This indicates that scale up of the method should be fairly straightforward.

Meanwhile, it is noted that a much higher concentration of carbon dioxide was observed on the CO₂ capture sensor. This is due to the increased volume of water used. In particular, the inventors noted that the 320,000 ppm sensor quickly reached its maximum cut off, and stayed above this maximum value long enough to suggest the potential for a 500,000 ppm result.

### Example 10—Further Large Scale Vacuum Extraction

In a bid to investigate the concentration of carbon dioxide being produced, a 100% CO₂ sensor was obtained, namely a Sprint IRW with top hat, and run on the Evolution 2.3 Software obtained from GSS. This was used to conduct further experiments. Additionally a Nixon 0.05-1.6 l/min gas flow meter was used.

These experiments involved 35 litres of seawater placed within the 76 litre chamber with the same set up as in previous section above. This time however, the pH was dropped to pH 3 and the testing was conducted in a chain of four tests in a bid to maintain a CO₂ concentration between tests and minimise the potential for air mixing with the fluid.

Each test was run for 10 minutes before being switched to a new batch of test fluid while introducing as little air to the test as possible between changeovers.

Typical flow rates were 0.35 l/min for 1 minute, 0.25 l/min for 1 minute, 0.2 l/min for a minute then a drop to approximately 0.1 l/min for 4 minutes and approximately 0.05 l/min for the remaining 3 minutes. The initial air in the chamber was removed prior to this measurement and this flow rate is thought to represent the gases being removed from the water phase. This gave an overall quantity of around 1.35 litres of gas in total over the 10 minutes. This measurement is not exact as the needle is not completely static but it felt to be a fair approximation.

In the first run, the maximum ppm was 225,000 ppm, in the second run, the maximum ppm was 320,000 ppm, in the third run, the maximum ppm was 370,000 ppm and in the fourth run, the maximum ppm was 380,000 ppm.

From this data, it is clear that the more air can be kept out of the system the higher the CO₂ yield rates and that the higher levels of yield can be maintained without significant drop.

A further test was attempted whereby only one test chamber was used, but prior to adding acid, the fluid in the chamber was tested for 10 minutes in an attempt to de-aerate the fluid prior to starting the main acid test. The initial de-aeration step, prior to addition of acid, yielded a result of 32,000 ppm which is in line with what the inventors would expect. The inventors also observed that the flow rates were much lower as less gas was being evolved. After this step, acid was added while minimising the amount of air being introduced into the system, and this test yielded a maximum ppm of 400,000 ppm after a 10 minute duration. This result indicates that the more air removed from the system, the higher the ppm yield.

Based on this, it is felt that on a larger volume scale subsea that 500,000 ppm is a completely reasonable expectation and pushing towards a stream of 92% carbon dioxide or higher is not out of the question, particularly if the pH of the water is lowered prior to extraction.

### Example 11—Modelling Carbon Dioxide Extraction from Produced Water

In a bid to establish how strong a stream of CO₂ might be obtainable from produced water, 2 g/litre of NaHCO₃ (Sodium Bicarbonate) was added to Balmerino tap water to mimic a high carbonate/bicarbonate level of produced water. This testing was conducted in the 12 l test chamber as described above, and the concentration of CO₂ measured using the Sprint IRW 100% CO₂ sensor.

4.5 l of this ‘produced’ water was added to the test vessel after addition of acid to pH 3.0. It is noted that it took 30 ml of 10% HCl to lower the pH as the fluid was heavily buffered by the carbonate.

The testing provided a maximum yield of 850,000 ppm of CO₂ (85%) and it is also noted that while in previous tests with this chamber there was insufficient gas flow to accurately register on the Nixon 0.05-1.6 l/min gauge, sufficient gas was being evolved that the reading was sitting at 0.4 l/min for several minutes before slowly dropping back.

From this it is clear that produced water with high carbonate levels offers enormous potential for CO₂ generation and that a pure stream of 92%+CO₂ would be achievable in the right circumstances.

### Example 12—Increasing the Concentration of Carbon Dioxide in the Water

Exhaust gases from power stations and diesel engines/generators/powerplants etc. have a higher percentage of CO₂ in them than atmospheric air. In particular, exhaust gas from a gas fired power station contains circa 5% CO₂, exhaust gas from a diesel engines contains circa 12% CO₂, exhaust gas from a coal-fired power station contains circa 15%, and exhaust gas from a cement or steel plant contains circa 30-35%.

Systems which use exhaust gases to increase the concentration of carbon dioxide in water are shown in FIGS. 3 and 4.

In particular, FIG. 3 shows a system that is configured for use with flue gases at pressures of about 10 to 15 bar. The system comprises a water inlet 34, where water is fed into a first conduit 36. A pump assembly 38 may be provided on the first conduit 36 to boost water pressure, if required. A first flow control valve/isolation valve 40 may be disposed on the first conduit 36 downstream of the pump 38.

A gas inlet 42 may feed a flue gas, which is preferably at a pressure between 10 and 15 bar, along a second conduit 44. A second flow control valve/isolation valve 46 may be disposed on the second conduit 44. The second conduit 44 may feed the gas through a gas inlet 48 into the first conduit, preferably downstream of the first flow control valve/isolation valve 40.

The first conduit 36 may extend between the gas inlet 48 and a pressure vessel 50. Carbon dioxide is more soluble in water than other gases, and so will dissolve preferentially. For example, the solubility of nitrogen and oxygen in water at atmospheric pressure and 20° C. is about 20 mg/L and 40 mg/L, respectively. Conversely, the solubility of carbon dioxide in water at atmospheric pressure and 20° C. is about 1,700 mg/L. Accordingly, contacting the flue gas and water in the first conduit 36 will significantly increase the concentration of the carbon dioxide in the water. As shown in FIG. 3, the length of the first conduit 36 between the gas inlet 48 and the pressure vessel 50 may be maximized to increase the contact time for the gas and water therein.

The pressure vessel 50 comprises a first vent 52 and a third flow control valve/isolation valve 54 configured to vent undissolved gas which is present in the pressure vessel 50. The pressure vessel 50 may further comprise an emergency vent 56 comprising a relief valve 58 to protect the pressure vessel 50. Preferably, the pressure vessel 50 is disposed at a local high point in the apparatus, to better enable undissolved gas to collect therein.

A third conduit 60 extends between the pressure vessel 50 and a carbon dioxide capture tank 62. The third conduit 60 is configured to carry water saturated with dissolved carbon dioxide 64 from the pressure vessel 50 to the capture tank 62. A fourth flow control valve/isolation valve 66 and/or an adjustable pressure relief valve 68 may be disposed on the third conduit 60. Preferably, the fourth flow control valve/isolation valve 66 and/or the adjustable pressure relief valve 68 are configured to reduce the pressure of the water 64.

Advantageously, due to the reduction in pressure, carbon dioxide will be released from the water 64 into the capture tank 62 to provide a gas with a high concentration of carbon dioxide 70. The capture tank 62 may comprise a gas outlet 72 to enable the gas 70 to be released from the tank and transported along a fourth conduit 74. The fourth conduit 74 may comprise a fifth flow control valve/isolation valve 76.

The capture tank 62 may further comprise an emergency vent 78 comprising a relief valve 80 to protect the capture tank 62.

Additionally, the capture tank 62 would further comprise a water outlet 82 to enable water to be removed from the capture tank 62. A fifth conduit 84 may be configured to transport water from the water outlet 82. An isolation valve 86 may be disposed on the fifth conduit 84. The fifth conduit 84 may be disposed to have a high point 88 which would correspond to the height that water would reach in the capture tank 62.

The gas with a high concentration of carbon dioxide 70 may be removed from the apparatus at outlet 90. The gas with a high concentration of carbon dioxide 70 may then be further processed to increase the concentration of carbon dioxide or to provide a commercial product. Alternatively, the gas with a high concentration of carbon dioxide 70 may be stored using known carbon dioxide capture and storage techniques.

Alternatively, or additionally, as shown in FIG. 3, the gas with a high concentration of carbon dioxide 70 could be combined with a flue gas. The flue gas may be fed through an isolation valve 92 into the fourth conduit 74 at a flue gas inlet 94.

The gas with a high concentration of carbon dioxide 70, optionally when combined with the flue gas, may then be fed through an isolation valve 96 into a further system 98 similar to the one described above, and contacted with water. This will provide an output gas with an even higher concentration of carbon dioxide.

FIG. 4 is similar to FIG. 3, except that the apparatus is designed for pressures exceeding 10-15 bar. The apparatus does not comprise a pressure vessel 50. Instead the first conduit 36 extends between the gas inlet 48 and the capture tank 62. Vents 90 are disposed at multiple high points along the first conduit 36. Each vent comprises a conduit 92 with a flow control/isolation valve 94 disposed thereon. Additionally, the fourth flow control valve/isolation valve 66 and/or an adjustable pressure relief valve 68 are be disposed on the first conduit 35.

The inventors' calculations suggest that if the flue gas 38 has a concentration of >10 vol % CO₂, then the output gas 48 could comprise about 92 vol % CO₂. If the CO₂ levels in the flue gas 38 were higher, then higher levels of CO₂ in the output gas could be obtained. As indicated above, if the output gas does not have a high enough concentration of CO₂ it can be contacted with an input liquid, which is subsequently degassed to provide a further output gas with a higher concentration of carbon dioxide.

### Example 13—Further Embodiment of the Invention

A buoyant vacuum extraction system 100 in accordance with the present invention is shown in FIG. 5.

The system 100 comprises a buoyant tank 102 which floats on the surface 104 of a body of water 106, such as a sea or ocean. Mooring cables 108 attach the buoyant tank 102 to a fixed structure, in FIG. 5 this is the seabed 110 but it will be appreciated that the tank 102 could be attached to any other fixed solid structure which could be natural or manmade. The mooring cables could be configured to allow the tank to be released from the structure and optionally repositions to allow relocation of the apparatus.

A riser 112 is configured to transport water, preferably from a predefined depth in the body of water, into the buoyant tank 102. The apparatus comprises a chemical injection system 114 configured to inject a chemical (e.g. an acid) into the riser 112. A control valve 116 may be disposed in the riser to control the flow of water into the tank 102.

The apparatus 100 may comprise multiple water inlets 118 configured distribute the water throughout the tank 102.

As shown in FIG. 5, the tank 102 may be filled with a nucleation material 120. Additionally, the water within the tank may be agitated due to movement of the tank, and optionally a further mechanical agitator.

The apparatus 100 comprises a vacuum system (not shown) configured to reduce the pressure in a headspace 122 in the tank 102. The vacuum system can be a vacuum pump, or vacuum pump array, configured to apply a reduced pressure in the headspace 122. The reduced pressure will cause carbon dioxide to be released from the water.

Accordingly, a gas with a high concentration of carbon dioxide 124 may be collected at a gas outlet 126. It is noted that the vacuum system will also cause water to be drawn along the riser 112 and into the tank 102.

The apparatus may further comprise one or more liquid outlets 128 configured to transport liquid out of tank 102. The liquid outlets 128 preferably discharge water above the surface of 104 of the body of water 106. The or each liquid outlet 128 may comprise an oxygenation nozzle. The oxygen nozzle is configured to add removed oxygen back to the water prior to release. Alternatively, or additionally, it can facilitate further removal of CO₂ using the method of bubbling air through the water to remove residual CO₂ still present.

### Example 14—Embodiment of the Invention in a Fossil Fuel Power Station

A system of the invention could be integrated into an industrial plant or power station. A suitable system is shown in FIG. 6. The system comprises a storage tank 130 which can store a gas with a high concentration of carbon dioxide, for instance a flue gas.

Power stations tend to produce millions of litres of flue gas per minute. Accordingly, it may not be practical to pressurise all of that gas to maximise solubility. The exhaust gas may instead be transported from the storage tank 130 through exhaust gas conduit 132 to a point in a lower portion of absorber tower 134. A sprayer 136 adjacent to the top of the absorber tower would spray water (or another solvent) into the tower. Accordingly, the gas would contact the water spray and carbon dioxide would be transferred to the water. The gas could then be vented from the top of the absorber tower 134.

The water can be collected at the bottom of the tower 134 and pumped along a water conduit 138 to a water collection cylinder 140. A suitable method known to those skilled in the art would reduce the pressure in the cylinder 140 to about 0.1 bar. A check valve 142 in the water conduit ensures that the pressure in the cylinder 140 is maintained at the reduced pressure. Accordingly, this will cause the carbon dioxide in the water to be released.

If the gas released from the water has too low a concentration of carbon dioxide (say for example 35 vol % CO₂, or less), then the gas could be contacted with the water again, either at ambient pressure or at a higher pressure. This step could be repeated multiple times if necessary as the concentration of carbon dioxide would increase with each iteration.

Once a gas with a high enough concentration of carbon dioxide has been produced it can be compressed, by a compressor 144, and stored in a gas store 146. Accordingly, a first gas conduit (not shown) may extend between the cylinder 140 and the compressor 144 and a second gas conduit 148 may extend between the compressor 144 and the gas store 146. In the embodiment shown, a further gas conduit 150 extends between a high point in the water conduit 138 and the gas store 146.

Additionally, a further water conduit 152 may extend from the bottom of the cylinder 140 to sprayer 136 to recycle the water.

The above apparatus could be powered by renewables such as a wind turbine.

In addition, as alluded to above, part of the process could involved pressurising a gas to an elevated pressure to improve solubility (for example to 20 bar). The gas could be pressurised at times of low energy demand. This would reduce any strain on the power plant.

Additionally, the pressurised gas could be contacted with water at the elevated pressure, to transfer the carbon dioxide to the water. The water could then be held at the elevated pressure in a storage facility and released during peak demand on the power station, at which point the evolved gas could be used to run a turbine to generate power. Essentially the pressurised solvent could act as a compressed air battery system. Again, the gas which is evolved when the pressure is reduced would contain a high concentration of carbon dioxide and could be captured and stored, as discussed above.

1. A method of capturing carbon dioxide, the method comprising:
providing an input liquid, wherein the input liquid comprises carbon dioxide, and/or a precursor thereof, dissolved therein;
degassing the input liquid to obtain an output gas comprising carbon dioxide; and
capturing the output gas and/or carbon dioxide present in the output gas.

2. The method of claim 1, wherein the output gas comprises a concentration of carbon dioxide of at least 750 ppm, at least 1,000 ppm, at least 5,000 ppm, at least 10,000 ppm, at least 20,000 ppm, at least 30,000 ppm, at least 40,000 ppm, at least 45,000 ppm, at least 50,000 ppm, at least 75,000 ppm, at least 100,000 ppm, at least 200,000 ppm, at least 300,000 ppm, at least 400,000 ppm, at least 500,000 ppm, at least 600,000 ppm, at least 700,000 ppm, at least 800,000 ppm, at least 900,000 ppm, or 1,000,000 ppm.

3. The method of claim 1, wherein the method comprises increasing the concentration of carbon dioxide and/or the precursor thereof in the input liquid prior to degassing the input liquid, wherein the concentration of carbon dioxide and/or the precursor thereof in the input liquid is increased by contacting the input liquid with a gas with a high concentration of carbon dioxide, optionally wherein the gas with a high concentration of carbon dioxide is a flue and/or exhaust gas.

4. (canceled)

5. The method according to claim 3, wherein the method comprises:
providing a first input liquid, wherein the input first liquid comprises carbon dioxide, and/or a precursor thereof, dissolved therein;
degassing the input first liquid to obtain a gas with a high concentration of carbon dioxide;
contacting the gas with a high concentration of carbon dioxide and a second input liquid;
degassing the second first liquid to obtain an output gas; and
capturing the output gas and/or carbon dioxide present in the output gas.

6. The method according to claim 3, wherein the gas with a high concentration of carbon dioxide comprises a concentration of carbon dioxide of at least 500 ppm, at least 1,000 ppm, at least 5,000 ppm, at least 10,000 ppm, at least 20,000 ppm, at least 30,000 ppm, at least 40,000 ppm, at least 45,000 ppm, at least 50,000 ppm, at least 75,000 ppm, at least 100,000 ppm, at least 125,000 ppm, at least 150,000 ppm, at least 175,000 ppm, at least 200,000 ppm, at least 300,000 ppm, at least 400,000 ppm, at least 500,000 ppm, at least 600,000 ppm, at least 700,000 ppm, at least 800,000 ppm or at least 900,000 ppm and/or wherein the method comprises contacting the input liquid and the gas with a high concentration of carbon dioxide at an increased pressure, wherein the increased pressure is a pressure of at least 200 kPa, at least 400 kPa, at least 600 kPa, at least 800 kPa or at least 1 MPa.

7. (canceled)

8. The method according to claim 1, wherein degassing the input liquid to obtain an output gas comprising carbon dioxide comprises contacting the input liquid with an input gas, and thereby causing carbon dioxide to be transferred from the input liquid to the input gas to produce an output gas, wherein the output gas comprises a higher concentration of carbon dioxide than the input gas, optionally wherein the input gas comprises less than 1,000 ppm carbon dioxide, less than 800 ppm carbon dioxide, less than 700 ppm carbon dioxide, less than 600 ppm carbon dioxide, less than 500 ppm carbon dioxide, less than 450 ppm or less than 430 ppm carbon dioxide.

9. (canceled)

10. The method according to claim 1, wherein degassing the input liquid comprises subjecting the input liquid to a reduced pressure.

11. The method according to claim 1, wherein the input liquid comprises water, optionally wherein the concentration of carbon dioxide and/or precursors thereof in the input liquid is at least 1 mol/kg, at least 10 μmol/kg, at least 50 μmol/kg, at least 100 μmol/kg, at least 500 μmol/kW, at least 1 mmol/kg or at least 1.5 mmol/kg.

12. (canceled)

13. The method according to claim 1, wherein the input liquid and the input gas are contacted in a batch process or in a continuous process.

14. (canceled)

15. The method according to claim 1, wherein the method comprises reducing the pH of the input liquid, optionally wherein the method comprises reducing the pH of the input liquid to less than 7, less than 6, less than 5, less than 4 or less than 3.5.

16. (canceled)

17. The method according to claim 1, wherein the method comprises increasing the pH of the output liquid, optionally wherein the method comprises increasing the pH of the output liquid to between 4 and 11, between 5 and 10, between 6 and 9.5, between 6.5 and 9 or between 7 and 8.5.

18. (canceled)

19. The method according to claim 1, wherein capturing the output gas comprises preventing the output gas, and/or the carbon dioxide disposed therein, from venting to the atmosphere and/or wherein the method further comprises separating the carbon dioxide from the output gas.

20. (canceled)

21. The method according to claim 1, wherein the method further comprises contacting the output gas, and/or carbon dioxide separated therefrom, with an absorbent or adsorbent material and/or a reactive compound, optionally wherein the absorbent or adsorbent material is or comprises a molecular sieve, an inorganic framework material, an organic framework material, a silica material, activated carbon, an amine, a metal hydroxide and/or an organic solvent.

22. (canceled)

23. The method according to claim 1, wherein the method comprises storing the output gas and/or carbon dioxide separated therefrom by pumping the output gas and/or carbon dioxide into an underground reservoir to capture the carbon dioxide; or reacting the carbon dioxide with another material to produce a commercially usable product; or utilizing the carbon dioxide in a biological process; and/or compressing the output gas or carbon dioxide to give liquid, solid or supercritical carbon dioxide.

24. (canceled)

25. (canceled)

26. (canceled)

27. An apparatus for capturing carbon dioxide, the apparatus comprising:
a degasser, comprising a degassing chamber, a liquid inlet configured to feed an input liquid comprising carbon dioxide, and/or a precursor thereof dissolved therein into the degassing chamber, and a liquid outlet, configured to remove an output liquid from the degassing chamber, wherein the degasser is configured to degas a liquid in the degassing chamber to obtain an output gas comprising carbon dioxide, and the degasser further comprises a gas outlet to remove the output gas from the degassing chamber; and
capture means configures to capture the output gas and/or carbon dioxide disposed therein which flows out of the gas outflow.

28. The apparatus of claim 27, wherein the apparatus comprises a contacting chamber configured to contact the input liquid and the gas with a high concentration of carbon dioxide, wherein the contacting chamber is disposed upstream of the degassing chamber and comprises: a liquid inlet, configured to feed the input liquid into the contacting chamber; a gas inlet, configured to feed the gas with a high concentration of carbon dioxide into the contacting chamber; and a gas outlet, configured to remove a gas from the contacting chamber, optionally wherein the apparatus comprises a plurality of degassing chambers arranged in series, wherein the gas outlet from a first degassing chamber is configured to feed the output gas into a gas inlet in the contacting chamber, and the contacting chamber is configured to feed the input liquid into a subsequent degassing chamber.

29. (canceled)

30. The apparatus according to claim 27, wherein the apparatus comprises a liquid pump configured to pump an input liquid into the liquid inlet.

31. The apparatus according to claim 27, wherein the degassing chamber comprises or is a processing conduit with first and second ends, and the degasser comprises a gas inlet, configured to feed an input gas into the processing conduit, and the gas outlet is configured to remove an output gas from the processing conduit, such that a gas flow path is defined in the processing conduit between the gas inlet and the gas outlet, and the liquid inlet is configured to feed the input liquid into the processing conduit and the liquid outlet is configured to remove the output liquid from the processing conduit, such that a liquid flow path is defined in the processing conduit between the liquid inlet and the liquid outlet, such that at least a portion of the liquid flow path overlaps at least a portion of the gas flow path.

32. The apparatus according to claim 27, wherein the degasser comprises a pressure reduction system, wherein the pressure reduction system is configured to reduce the pressure and/or creating a vacuum in the degassing chamber and/or wherein the degasser and/or the degassing chamber is configured to be at least partially disposed in a body of water.

33. (canceled)

34. The apparatus according to claim 27, wherein the apparatus comprises a first pH adjustment means configured to adjust the pH of the input liquid and/or wherein the apparatus comprise a second pH adjustment means configured to adjust the pH of the output liquid.

35. (canceled)
